(19) United States
(12) Patent Application Publication
(10) Pub. No.: US 2019/0187363 A1
(43) Pub. Date: Jun. 20, 2019

(54) LIGHTING DEVICE AND DISPLAY DEVICE

(71) Applicant: SHARP KABUSHIKI KAISHA, Sakai City, Osaka (JP)

(72) Inventor: MITSURU HOSOKI, Sakai City (JP)

(21) Appl. No.: 16/326,532

(22) PCT Filed: Aug. 17, 2017
(86) PCT No.: PCT/JP2017/029525

§ 371 Date: Feb. 19, 2019

(30) Foreign Application Priority Data
Aug. 24, 2016 (JP) 2016-163754

(51) Int. Cl. F21V 8/00

(52) U.S. Cl. CPC G02B 6/0088; G02B 6/0073; G02B 6/0068; G02B 6/0055; G02B 6/0051; G02B 6/0053

(57) ABSTRACT

A backlight unit includes an optical sheet set, LEDs arranged on one edge side of the optical sheet set with respect to a first direction, a sheet supporter supporting another edge side section of the optical sheet set with respect to the first direction, a support section supported by the sheet supporter, and a contact section. The contact section is a part of the support section to be contacted with the sheet supporter and includes a middle side section and an edge side section that are continuous to each other. At least the middle side section extends from the edge side section obliquely with respect to the first direction and the second direction and toward the one edge side with respect to the first direction and the middle side section has an inclination angle θ1 with respect to the second direction greater than that of the edge side section.

### TECHNICAL FIELD

The present invention relates to a lighting device and a display device.

### BACKGROUND ART

A liquid crystal display device includes a liquid crystal panel of a rectangular display screen, the rectangular optical sheet, and a backlight. The optical sheet is suspendedly supported by fitting a plurality of pins in a plurality of holes formed in the peripheral edge part of the optical sheet. The plurality of holes include a plurality of long-side holes and plurality of short-side holes in the long-side peripheral edge parts and the short-side peripheral edge parts of the optical sheet. The long-side holes include a positioning hole having a positioning part with a long-side parallel directional dimension substantially equal to a diameter of the pin and support holes provided with an edge part with a long-side dimension parallel to the long side and larger than the diameter of the pin. The short side holes includes a positioning hole having a positioning part with a short-side parallel directional dimension substantially equal to the diameter of the pin and support holes provided with an edge part with a short-side dimension parallel to the short side and larger than the diameter of the pin. Such a liquid crystal display device is disclosed in Patent Document 1.

### RELATED ART DOCUMENT

### Patent Document

Patent Document 1: Japanese Unexamined Patent Application Publication No. 2009-139572

### Problem to be Solved by the Invention

Such a liquid crystal display device described in Patent Document 1 is used a horizontal position and a vertical position. However, the optical sheet is configured to thermally expand with reference to a supported section fixed with pins. The supported section is an expansion starting point. Therefore, a frame width of the display device is necessarily increased by the expansion dimension according to the thermal expansion and this hinders reduction of the frame width.

### DISCLOSURE OF THE PRESENT INVENTION

The present invention was made in view of the above circumstances. An object is to reduce a frame width.

### Means for Solving the Problem

A lighting device the present invention includes an optical sheet having a surface along a first direction and a second direction that are perpendicular to each other and adding an optical effect to light, a light source arranged on one edge side of the optical sheet with respect to the first direction, a sheet supporter configured to support another edge side section of the optical sheet with respect to the first direction, a support section included in the other edge side section of the optical sheet and closer to an edge side from a middle position of the optical sheet with respect to the second direction, the support section being supported by the sheet supporter, and a contact section that is included in a section of the support section and to be contacted with the sheet supporter. The contact section includes a middle side section and an edge side section on a middle side and an edge side of the optical sheet with respect to the second direction, respectively, and the middle side section is continuous to the edge side section. At least the middle side section extends from the edge side section obliquely with respect to the first direction and the second direction and toward the one edge side with respect to the first, direction and the middle side section has an inclination angle with respect to the second direction that is greater than that of the cage side section.

According to such a configuration, the light emitted by the light source that is arranged on the one edge side of the optical sheet in the first direction supplied to the surface of the optical sheet parallel to the first direction and the second direction. Then, the optical effects are added to the light by the optical sheet. The optical sheet is supported by the sheet supporter that is contacted with the contact section of the support section in the first direction. The support section is included on the other edge side of the optical sheet in the first direction and on edge side with respect to the middle position in the second direction. The optical sheet thermally expands in the first direction and the second direction according to the increase of the temperature. Accordingly, the sheet supporter thats contacted with the edge side section of the contact section relatively moves to be contacted with the middle side section. Specifically, first, in the relatively low temperature environment, the sheet supporter is contacted with the edge side section of the contact section of the support section included in the optical sheet. The side edge section has an inclination angle with respect to the second direction smaller than that of the middle side section. Therefore, if the optical sheet thermally expands according to the increase of the environment temperature, the sheet supporter is guided along the edge side section and the optical sheet expands such that the one edge side section thereof in the first direction moves farther away from the other edge section in the first direction.

According to the thermal expansion of the optical sheet, an object that is to be contacted with the sheet supporter is shifted from the edge side section to the middle side section of the contact section. The middle side section extends obliquely with respect to the first direction and the second direction and extends from the edge side section toward the one edge side with respect to the first direction. The inclination angle of the middle side section with respect to the second direction is greater than that of the edge side section. According to such a configuration, if the optical sheet thermally expands according to the further increase of the temperature, the sheet supporter is guided along the middle side section and the optical sheet expands such that the other edge section thereof in the first direction moves farther away from the one edge section in the first direction. Accordingly, the deformation such as wrinkles or warping is less likely to be caused in the optical sheet according to the thermal expansion.

The optical sheet expands at the one edge section and the other edge section thereof if the optical sheet thermally expands in the first direction. Therefore, compared to a configuration in which the optical sheet expands only at the one edge section according to the thermal expansion in the first direction, the frame width of at least one edge side can be decreased. Accordingly, the width dimension of the frame can be preferably decreased. According to the decrease of the frame width dimension, the light emitted by the light source may not enter the optical sheet and is likely to leak outside without passing through the optical sheet. In a relatively low temperature environment, the sheet supporter is contacted with the edge side section of the contact section and the optical sheet thermally expands such that the one edge section moves away from the other edge section in the first direction. Therefore, even if the frame width is decreased, the light from the light source that is disposed on the one edge side of the optical sheet in the first direction is less likely to leak without entering the optical sheet. Namely, the light leaking is less likely to be caused while the frame width being reduced.

Preferable embodiments of the present invention may include the following configurations.

(1) The contact section may be formed such that a tangent of the inclination angle of the middle side section with respect to the second direction is equal to a ratio of a distance between the middle position of the optical sheet in the second direction and the support section to a dimension of the optical sheet in the first direction. According to such a configuration, if the optical sheet thermally expands further while the sheet supporter being contacted with the middle side section, the sheet supporter is guided along the middle side section and the optical sheet expands such that the other edge section in the first direction moves farther away from the one edge section in the first direction and does not expand at the one edge section thereof to be away from the other edge section.

(2) The edge side section of the contact section may extend in the second direction. According to such a configuration, if the optical sheet thermally expands while the sheet supporter being contacted with the edge side section, the sheet supporter slides along the edge side section and the optical sheet expands such that the one edge section in the first direction moves farther away from the other edge section in the first direction and does not expand at the other edge section to be farther away from the one edge section.

(3) The lighting device may further include a middle support section included on the other edge side and in the middle position of the optical sheet with respect to the second direction and having a hole, and a middle sheet supporter configured to support the middle support section and to be inserted through the hole of the middle support section. The hole may have a dimension in the first direction that is greater than that of the middle sheet supporter. According to such a configuration, the optical sheet is supported at the other edge section thereof in the first direction by the middle sheet supporter that inserted through the middle hole of the middle support section. The middle support section is included in the middle position of the optical sheet in the second direction. If the optical sheet thermally expands, the middle side support section relatively moves in the first direction with respect to the middle sheet supporter. The middle hole in the middle support section extends in the first direction and has a dimension in the first direction that is greater than that of the middle sheet supporter. Therefore, the middle hole allows the relative movement of the middle support section.

(4) The lighting may further include a sheet receiving section arranged on an opposite side from the sheet supporter with respect to the first direction while having the optical sheet therebetween and the sheet receiving section may be configured to receive a one edge side section of the optical sheet with respect to the first direction. The sheet receiving section may be away from the one edge side section of the optical sheet in a relatively low temperature environment and the sheet receiving section may be in contact with the one edge side section of the optical sheet in a relatively high temperature environment. According to such a configuration, if the optical sheet thermally expands such that the one edge section thereof in the first direction moves farther away from the other edge section in the first direction, the one edge section is received by the sheet receiving section and the optical sheet is less likely to expand further at the one edge section and is supported in the first direction. If the optical sheet thermally expands further, the optical sheet expands such that the other edge section thereof in the first direction moves farther away from the one edge section. Thus, the optical sheet is supported by the sheet supporter and the sheet receiving section at the one edge section and the other edge section in the first direction. Therefore, the optical sheet is supported stably.

(5) The lighting device may further include a frame member extending along an outer edge of the optical sheet and the frame member may include the sheet supporter and the sheet receiving section. Since the frame includes the sheet supporter and the sheet receiving section, the sheet supporter and the sheet receiving section are positioned with high arrangement accuracy and the number of components is reduced.

(6) The contact section may includes at least two contact sections having the sheet supporter therebetween. According to such a configuration, the sheet supporter sandwiched by the at least two contact sections that are opposite each other and is contacted with the contact sections. Therefore, the support section relatively moves with respect to the sheet supporter smoothly according to the thermal expansion of the optical sheet.

(7) The support section may be a projection projecting from a part of an outer edge of the optical sheet. According to such a configuration, the optical sheet is not increased in size as a whole and a material cost for the optical sheet can be reduced.

(8) The lighting device may further include a middle support section and a middle sheet supporter. The middle support section may be included on the other edge side and in the middle position of the optical sheet with respect to the second direction and the middle support section may project from the outer edge of the optical sheet toward a same side as the support section in the first direction. The middle sheet supporter may be configured to support the middle support section. According to such a configuration, the support section can be arranged in the space provided for the middle support section. Therefore, compared to a configuration including the support section projecting from the outer edge of the optical sheet in the second direction, the optical sheet can be reduced in size in the second direction.

(9) The lighting device may further include a second sheet supporter configured to support a one edge side section of the optical sheet, a second support section included in the one edge side section of the optical sheet and supported by the second sheet supporter, and a second contact section included in a section of the second support section that is to be contacted with the second sheet supporter. The second contact section may include a second middle side section and a second edge side section on a middle side and an edge side of the optical sheet with respect to the second direction, respectively, and the second middle side section may be continuous to the second edge side section. At least the second edge side section may extend from the second middle side section obliquely with respect to the first direction and toward an opposite side from the other edge side with respect to the first direction and the second edge side section may have an inclination angle with respect to the second direction greater than that of the second middle side section. According to such a configuration, the optical sheet thermally expands in the first direction and the second direction according to the increase of the temperature and the second sheet supporter that is contacted with the second edge side section of the second contact section relatively moves to be contacted with the second middle side section. Specifically, first, in the relatively low temperature environment, the second sheet supporter is contacted with the second edge side section of the second contact section of the second support section included in the optical sheet. The second edge side section extends from the second middle side section obliquely toward the opposite side from the other edge side in the first direction. The second edge side section has an inclination angle with respect to the second direction greater than that of the second middle side section. Therefore, if the optical sheet thermally expands according to the increase of the environment temperature, the second sheet supporter is guided along the second edge side section and the optical sheet expands such that the other edge side section thereof in the first direction moves farther away from the other edge section in the first direction. An object that is to be contacted with the second sheet supporter is shifted from the second edge side section to the second middle side section of the second contact section according to the thermal expansion of the optical sheet. The inclination angle of the second middle side section with respect to the second direction is smaller than that of the second edge side section. According to such a configuration, if the optical sheet thermally expands according to the further increase of the temperature, the second sheet supporter is guided along the second middle side section and the optical sheet expands such that the other edge section thereof in the first direction moves farther away from the one edge section in the first direction. Accordingly, the deformation such as wrinkles or warping is less likely to be caused in the optical sheet according to the thermal expansion. As described before, the optical sheet is supported by the second sheet supporter and the sheet supporter at the one edge section and the other edge section thereof in the first direction. Therefore, the optical sheet is supported more stably.

(10) The second contact section may be formed such that a tangent of the inclination angle of the second edge side section with respect to the second direction is equal to a ratio of a distance between the middle position of the optical sheet in the second direction and the second support section to a dimension of the optical sheet in the first direction. According to such a configuration, if the optical sheet thermally expands further while the second sheet supporter being contacted with the second edge side section, the second sheet supporter is guided by the second edge side section and the optical sheet expands such that the one edge section in the first direction moves farther away from the other edge section in the first direction and does not expand at the other edge section thereof to be away from the one edge section.

(11) The second middle side section of the second contact section may extend in the second direction. According to such a configuration, if the optical sheet thermally expands while the second sheet supporter being contacted with the second middle side section, the second sheet supporter is guided by the second middle side section. Accordingly, the optical sheet expands such that the other edge section in the first direction moves away from the one edge section in the first direction and does not expand at the one edge section to be away from the other edge section.

(12) The second support section may have an open section where the second sheet supporter is fit and that is open toward an opposite side from the other edge side of the optical sheet with respect to the first direction. According to such a configuration, compared to a configuration including a second open section that is a hole through the second support section, the second support section is reduced in size and the frame width can be further reduced.

Next, to solve the above problem, a display device of the present invention includes the above lighting device and a display panel displaying an image with using light supplied by the lighting device. According to the display device having the above configuration, the frame width of the lighting device can be reduced and an outer appearance is improved.

### Advantageous Effect of the Invention

According to the present invention, a frame width can be reduced.

### BRIEF DESCRIPTION OF THE DRAWINGS

FIG. 1 is an exploded perspective view illustrating a general configuration of a television device according to a first embodiment of the present invention.

FIG. 2 is an exploded perspective view illustrating a general configuration of and crystal display device included in the television device.

FIG. 3 is a plan view illustrating a chassis, a LED board, and a light guide plate included in a backlight unit of a liquid crystal display device.

FIG. 4 is a cross-sectional view illustrating a cross-sectional configuration of the liquid crystal display device taken along a short-side direction.

FIG. 5 is a plan view illustrating a frame and an optical sheet set in a lowest temperature environment.

FIG. 6 is a plan view of the optical sheet set.

FIG. 7 is a plan view of a frame.

FIG. 8 is a plan view of the frame and the optical sheet set in a first normal temperature environment.

FIG. 9 is a plan view of the frame and the optical sheet set in a second normal temperature environment.

FIG. 10 is a plan view of the frame and the optical sheet set in a highest temperature environment.

FIG. 11 is a plan view of a frame and an optical sheet set in a lowest temperature environment according to a second embodiment of the present invention.

FIG. 12 is a plan view of the frame and the optical sheet set in the first normal temperature environment.

FIG. 13 is a plan view of the frame and the optical sheet set in the second normal temperature environment.

FIG. 14 is a plan view of the frame and the optical sheet set in the highest temperature environment.

FIG. 15 is a plan view of a frame and an optical sheet set in a lowest temperature environment according to a third embodiment of the present invention.

FIG. 16 is a plan view of the frame and the optical sheet set in the first normal temperature environment.

FIG. 17 is a plan view of the frame and the optical sheet set in the second normal temperature environment.

FIG. 18 is a plan view of the frame and the optical sheet set in the highest temperature environment.

FIG. 19 is a plan view of a frame and an optical sheet set in the highest temperature environment according to a fourth embodiment of the present invention.

FIG. 20 is a plan view of a frame and as optical sheet set in the highest temperature environment according to a fifth embodiment of the present invention.

FIG. 21 is a plan view of a frame and an optical sheet set in the highest temperature environment according to a sixth embodiment of the present invention.

### MODES FOR CARRYING OUT THE INVENTION

### First Embodiment

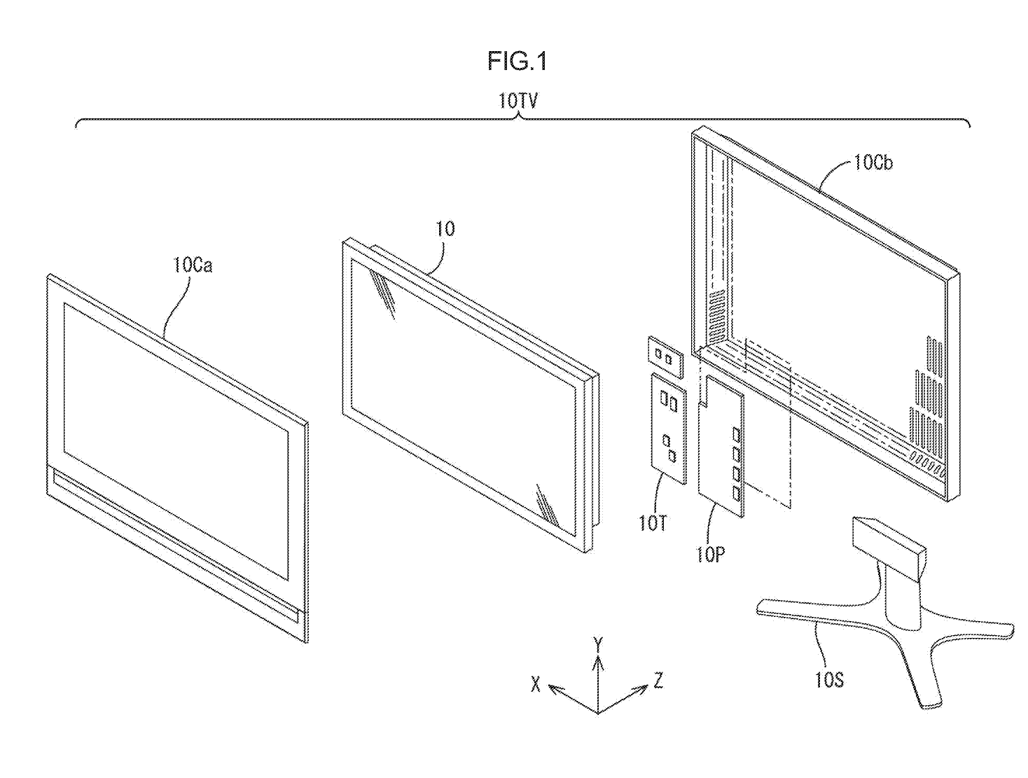

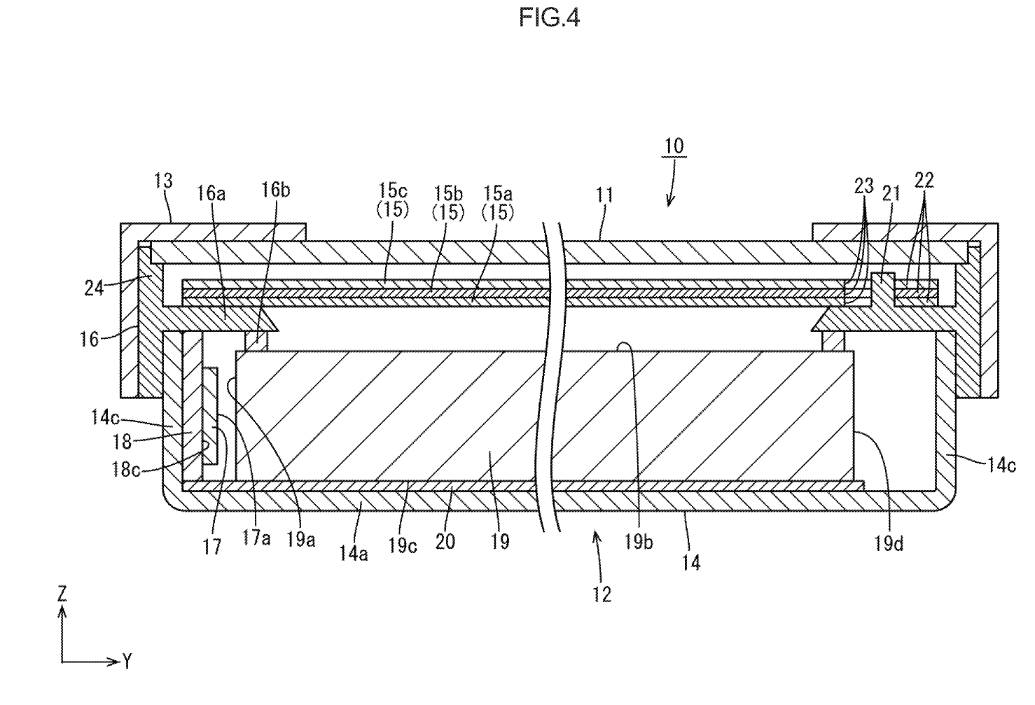

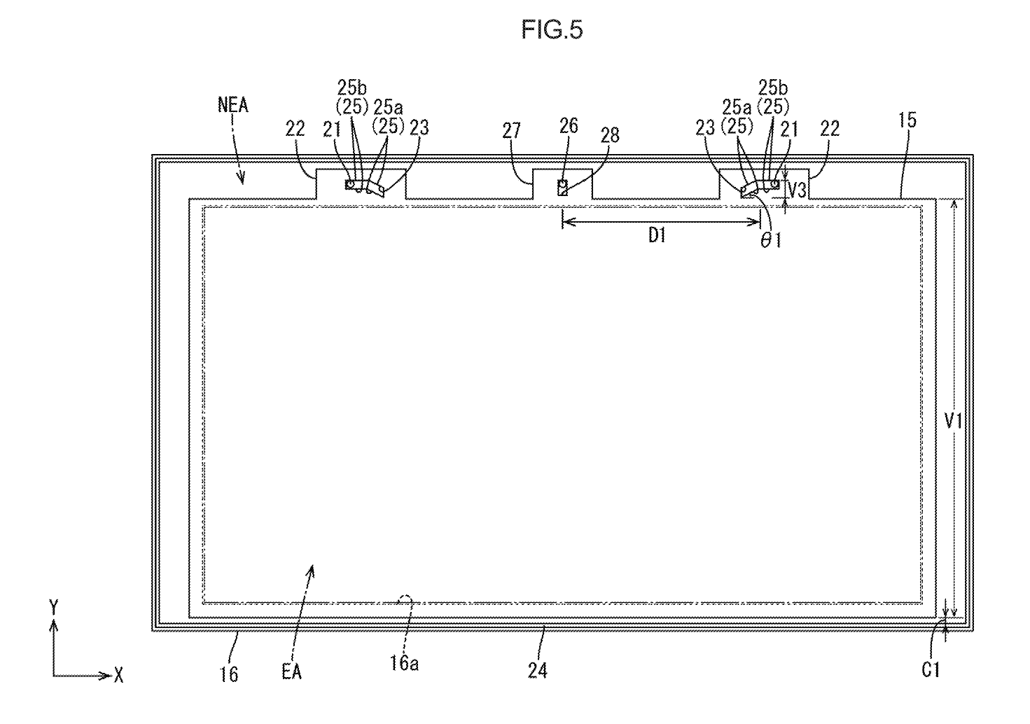

A first embodiment will be described with reference to FIGS. 1 to 10. In the present embodiment, a backlight unit 12 and a liquid crystal display device 10 including the backlight unit 12 will be described X-axis, Y-axis and Z-axis may be indicated in the drawings. The axes in each drawing correspond to the respective axes in other drawings. The Y-axis direction substantially matches a vertical direction (a first direction) and the X-axis direction substantially matches a horizontal direction (a second direction). An upper side and a lower side are defined based on the vertical direction (FIGS. 5 to 10). An upper side and a lower side in FIG. 4 correspond to a front side and a back side of the liquid crystal display; device, respectively. A left side and a right side in FIG. 4 correspond to a lower side and an upper side with respect to the vertical direction, respectively.

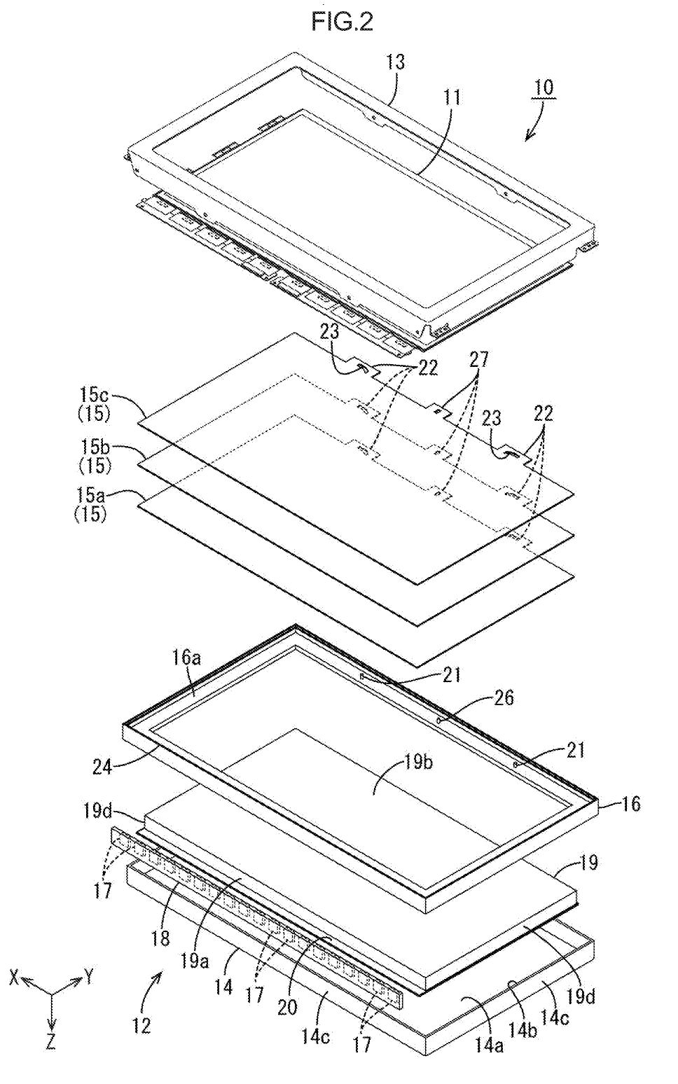

As illustrated in FIG. 1, a television device TV of this embodiment includes the liquid crystal display device 10, front and rear cabinets 10Ca, 10Gb that sandwich and house the liquid crystal display device 10 therebetween, a power supply 10P, a tuner (a receiver) 10T configured to receive television signals, and a stand 10S. The liquid crystal display device (the display device) 10 has a laterally elongated rectangular (quadrangular) as a whole and is arranged in a vertical position. As illustrated in FIG. 2, the liquid crystal display device 10 includes a liquid crystal panel (display panel) 11 displaying images, a backlight unit (a lighting device) 12, and a frame-like bezel 13. The backlight unit 12 is an external light source that supplies light to the liquid crystal panel 11 for display. The above components are held together with the bezel 13.

Next, the liquid crystal panel 11 and the backlight unit 12 included in the liquid crystal display device 10 will be described. The liquid crystal panel (a display panel) 11 has a laterally elongated rectangular plan view shape. The liquid crystal panel 11 includes glass substrates that are bonded to each other having a certain gap therebetween liquid crystal layer is enclosed between the glass substrates and the liquid crystal layer includes liquid crystal molecules having optical characteristics that vary according to application of electric field. Switching components (such as TFTs) and pixel electrodes are arranged in a matrix on the inner surface of one of the glass substrates (an array substrate, an active matrix substrate). The switching components are connected to source lines and gate lines that are perpendicular to each other. The pixel electrodes are arranged in square regions surrounded by the source lines and the gate lines and connected to the switching components. Further, an alignment film is arranged on the inner surface of the array substrate. On another one of the glass substrates (a counter substrate, a CF substrate), color filters, a light blocking layer (a black matrix), a counter electrode, and an alignment film, are arranged on an inner surface side thereof. The color filters include red (R), green (G), and blue (B) color portions that are arranged in a matrix with certain arrangement. The light blocking layer is formed between the color portions and formed in a grid. The counter electrode is disposed in a solid pattern and opposite the pixel electrodes. Polarizing plates are disposed on outer surfaces of the glass substrates. The long-side direction, the short-side direction, and a thickness direction of the liquid crystal panel 11 correspond to the X-axis direction, the Y-axis direction, and the Z-axis direction, respectively.

As illustrated in FIG. 2, the backlight unit 12 includes a chassis 14, an optical sheet set 15, and a frame (a frame member) 16. The chassis 14 has a box-like shape having a light exit section 14b opening toward the front (on a liquid crystal panel 11 side, a light exit side). The optical sheet set 15 is arranged so as to cover the light exit section 14b of the chassis 14. The frame 16 receives the optical sheet set 15 from the back side. Within the chassis 14, LEDs 17, which are a light source), an LED board 18 on which the LEDs 17 are mounted, a light guide plate 19, and a reflection sheet (a reflecting member) 20 are arranged. Light emitted by the LEDs 17 travels within the light guide plate 19 toward the optical sheet set 15 (the liquid crystal panel 11). A reflection sheet 20 is disposed on the back surface side of the light guide plate 19. The backlight unit 12 includes the LED board 18 on one of the long-side edge sections (on a lower side in a vertical direction) and the LEDs 17 mounted on the LED board 18 are locally arranged on only one long-side edge section of the liquid crystal panel 11. The backlight unit 12 of this embodiment is an edge-light type (side-light type) and light emitted by the LEDs 17 enters the light guide plate 19 through only one side edge. Namely, the LEDs 17 are arranged on only one edge section (the lower edge section) with respect to the optical sheet set 15 in the Y-axis direction (the first direction, the vertical direction). Next, each component of the backlight unit 12 will be described in detail.

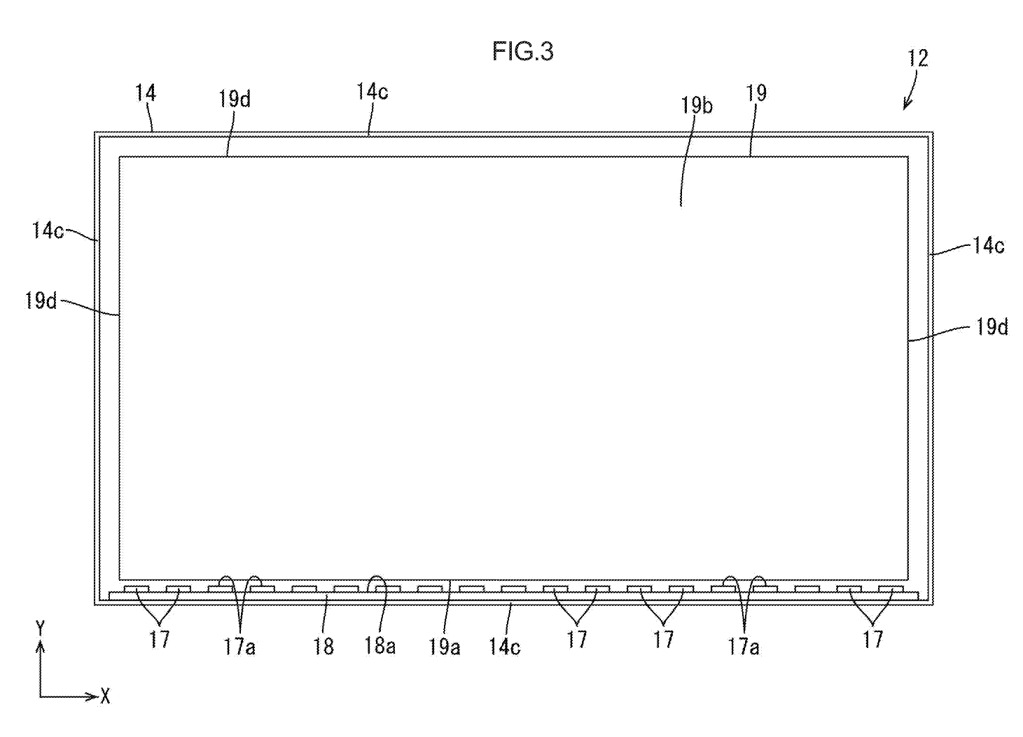

The chassis 14 is made of metal and as illustrated in FIGS. 2 and 3, the chassis 14 has a shallow box shape as a whole opening toward the front. The chassis 14 includes a bottom plate 14a and wall plates 14c. The bottom plate 14a has a laterally elongated rectangular shape. The wall plates 14c rise from edges of the bottom plate 14a, respectively. The chassis 14 (the bottom plate 14a) has the long-side direction and the short-side direction that correspond to the X-axis direction (the horizontal direction) and the Y-axis direction (the vertical direction), respectively. The frame 16 and the bezel 13 are fixed to the wall plates 14c.

As illustrated in FIG. 2, the optical sheet set 15 has a laterally elongated rectangular plan view shape similar to the liquid crystal panel 11 and the chassis 14 and includes a X-Y plane surface. The surface is parallel to the X-axis direction (the horizontal direction, the second direction) and the Y-axis direction (the vertical direction, the first direction) that are perpendicular to each other. The optical sheet set 15 covers the light exit section 14b of the chassis 14 and is between the liquid crystal panel 11 and the light guide plate 19. Namely, the optical sheet set 15 is on an exit side of a light exit path with respect to the LEDs 17. The optical sheet set 15 (an optical member) is configured to direct light emitted the LEDs 17 toward the liquid crystal panel 11 while adding specific optical effects to the light. Specifically, the optical sheet set 15 of this embodiment includes three optical sheets of a microlens sheet 15a, a prism sheet 15b, and a reflection type polarizing sheet 15c. The microlens sheet 15a applies an isotropic light collecting effect to the light emitted by the LEDs 17. The prism sheet 15b applies an anisotropic light collecting effect to the light. The reflection type polarizing sheet 15c reflects light with polarizing. As illustrated in FIG. 4, the optical sheet set 15 includes the microlens sheet 15a, the prism sheet 15b, and the reflection type polarizing sheet 15c that are stacked in this order from the back side. The outer edge sections of the sheets are placed on the front side surface of the frame 16. Namely, the microlens sheet 15a, the prism sheet 15b, and the reflection type polarizing sheet 15c included in the optical sheet set 15 are arranged opposite the light guide plate 19 and spaced therefrom at a distance corresponding to a dimension of the frame 16 (the frame section 16a). The sheets are arranged on the front side of (on the light exit side) the light guide plate 19.

The microlens sheet 15a includes a base member and microlenses that are arranged in the X-axis direction and the Y-axis direction on a plate surface of the base member. The light is collected in an isotropic pattern with respect to the X-axis direction the Y-axis direction while transmitting through the microlens sheet 15a. The prism sheet 15b includes a base member and prisms that extend in the X-axis direction and the Y-axis direction on a plate surface of the base member. The light is collected selectively only in an arrangement direction of the prisms while transmitting through the prism sheet 15b. The reflection type polarizing sheet 15c includes a reflection type polarizing film that reflects and polarizes light and a pair of diffuser films that sandwich the reflection type polarizing film from front and rear sides. The reflection type polarizing sheet 15c transmits p-waves included in the transmission light rays and reflects s-waves toward the back side such that the s-waves that are to be absorbed by the polarizing plate of the liquid crystal panel can be reused to improve light use efficiency (and brightness).

As illustrated in FIG. 2, the frame 16 includes a laterally elongated frame section (a frame edge section, a frame support section) 16a extending along peripheral edges of the light guide plate 19 and the optical sheet set 15. Substantially entire peripheral edge of the light guide plate 19 is pressed by the frame section 16a from the front side. The frame section 16a of the frame 16 is present between the optical sheet set 15 and the light guide plate 19 and receives the peripheral edge of the optical sheet set 15. Accordingly, the optical sheet set 15 is kept away from the light guide plate 19 while having a space corresponding to the dimension of the frame section 16a. A cushioning member 16b, for example PORON®, is arranged on the back side surface (the light guide plate 19 side) of the frame section 16a of the frame 16. The cushioning member 16b has a frame shape extending over an entire periphery of the frame section 16a.

As illustrated in FIGS. 3 and 4, the LEDs 17 are mounted on the LED board 18 and have light emission surfaces 17a facing an opposite side from the light guide plate 19 and are so-called top surface light emission type. The LED 17 includes an LED chip that emits light in a single color of blue. In the resin that seals the LED chip, phosphors (yellow phosphors, green phosphors, and red phosphors) are dispersed. An overall color of light emitted by the phosphors is substantially white.

As illustrated in FIGS. 3 and 4, the LED board 18 is an elongated plate extending in a long side direction of the chassis 14 (the X-axis direction). The LED board 18 is arranged in the chassis 14 such that a mount surface 18a on which the LEDs 17 are mounted is opposite an edge surface of the light guide plate 19. The LED board 18 is mounted on the chassis 14 such that a plate surface opposite from the mount surface 18a having the LEDs 17 is contacted with an inner surface of the lower wall plate 14c of the chassis 14 (with respect to the vertical direction). Wiring for supplying power to the LEDs 17 is formed on the LED 17 mount surface 18a of the LED board 18 and the LEDs 17 are mounted on the mount surface 18a at intervals in the X-axis direction.

The light guide plate 19 is made of substantially transparent synthetic resin having a refraction index sufficiently higher than that of air (acrylic resin such as PMMA or polycarbonate). As illustrated in FIGS. 2 and 4, the light guide plate 19 is arranged directly below the liquid crystal panel 11 and the optical sheet set 15 within the chassis 14 such that a plate surface thereof faces the liquid crystal panel 11 and the optical sheet set 15. As illustrated in FIG. 3, the light guide plate 19 is a plate that is thicker than the optical sheet set 15 and has a laterally elongated rectangular plan view shape. The light guide plate 19 includes peripheral edge surfaces that are a pair of short-side edge surfaces and a pair of long-side edge surfaces that are perpendicular to each other. A lower one of the long-side edge surfaces in the vertical direction among the peripheral edge surfaces of the light guide plate 19 is opposite the LEDs 17 and configured as a light entering edge surface 19a (a light source opposite edge surface). The light emitted by the LEDs 17 directly enters the light guide plate 19 through the light entering edge surface 19a. Other three peripheral edge surfaces of the light guide plate 19 (the other one of the long-side edge surfaces and a pair of short-side edge surfaces) are not opposite the LEDs 17 and configured as non-light entering edge surfaces 19d (light source non-opposite edge surface) through which light from the LEDs 17 does not enter directly. The light guide plate 19 has front and back plate surfaces and a front plate surface (opposite the liquid crystal panel 11 and the optical sheet set 15) is configured as a light exiting plate surface 19b and a back plate surface is configured as an opposite plate surface 19c that is opposite from the light exiting plate surface 19b. The light exits the light guide plate 19 through the light exiting plate surface 19b toward the liquid crystal panel 11 and the optical sheet set 15. According to such a configuration, light emitted by the LEDs 17 in the Y-axis direction enters the light guide late 19 through the light entering edge surface 19a and travels within the light guide plate 19 and is directed in the Z-axis direction and exits the light guide plate 19 through the light exiting plate surface 19b toward the optical sheet set 15 (the front side, the light exit side).

The optical sheet set 15 and the light guide plate 19 are an optical member that provides optical effects to the transmission light in the backlight unit 12. As illustrated in FIGS. 3 and 5, the optical sheet set 15 and the light guide plate 19 include an effective light emission area EA in a middle section thereof and a non-effective light emission area NEA in a frame-shaped peripheral edge section thereof surrounding the effective light emission area EA. Light exits effectively through the effective light emission area EA and does not exit effectively through the non-effective light emission area NEA. A border between the effective light emission area EA and the non-effective light emission area NEA substantially matches an inner peripheral edge of the frame section 16a of the frame 16 and also substantially matches a border between a display area and a non-display area of the liquid crystal panel 11. Images are displayed in the display area and no image is displayed in the non-display area. FIGS. 5, 8, and 10, the border between the effective light emission area EA and the non-effective light emission area NSA is illustrated with a dashed line.

As illustrated in FIG. 4 the reflection sheet 20 is disposed such that a plate surface thereof faces a plate surface of the light guide plate 19 and covers the opposite plate surface 19c of the light guide plate 19. The reflection sheet 20 has a good light reflection property and reflects effectively the light rays leaking through the opposite surface 19c of the light guide plate 19 toward the front side (the light exiting plate surface 19b). The reflection sheet 20 has an outline shape slightly greater than that of the light guide plate 19 and the lower long-side edge section thereof in the vertical direction extends further toward the LEDs 17 from the light entering edge surface 19a.

As illustrated in FIG. 5, the backlight unit 12 of this embodiment includes a sheet support structure (another end side sheet support structure, an upper side sheet support structure, a first sheet support structure, a sheet hanging structure). The sheet support structure is configured to support (suspend) the optical sheet set 15 vertically (in the Y-axis direction, the first direction) while allowing the optical sheet set 15 to thermally expand and contract. The sheet support structure includes a sheet supporter 21 (another end side sheet supporter, an upper side sheet supporter, a first sheet supporter) and a support section 22 (another end side support section, an upper side support section, a first support section). The sheet supporter 21 supports an upper end section (another end selection, a section opposite from the LEDs 1)) of the optical sheet set 15 in the vertical direction. The support section 22 is included in an upper edge section of the optical sheet set 15 in the vertical direction and has a hole 23 (another end side hole, an upper side hole, a first hole) through which the sheet supporter 21 inserted. The support section 22 is supported by the sheet supporter 21 that is inserted through the hole 23.

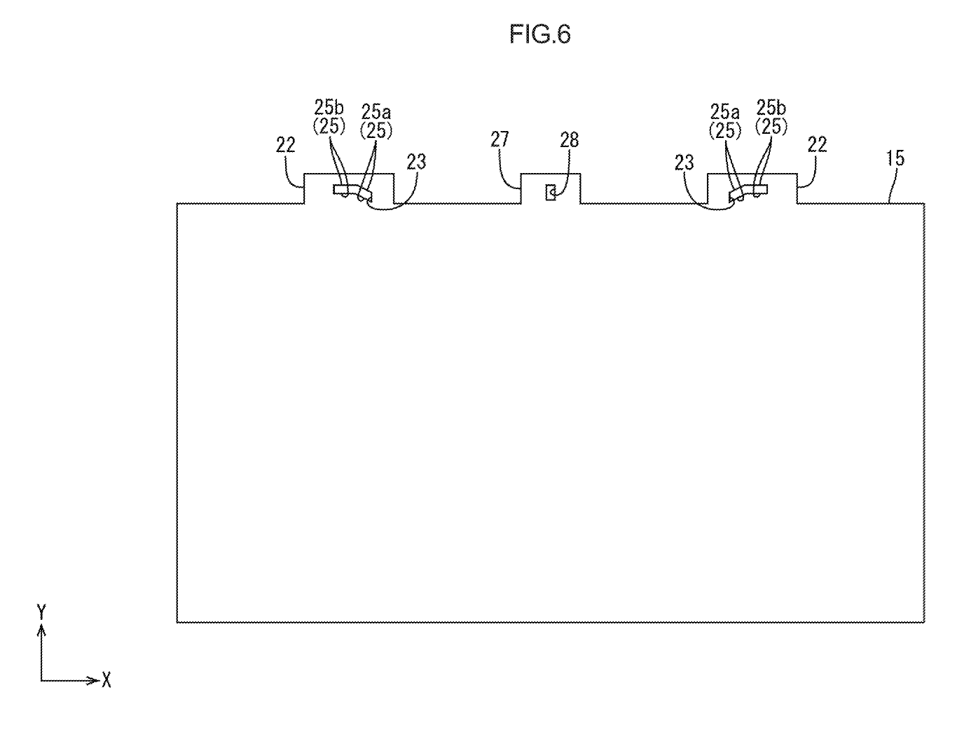

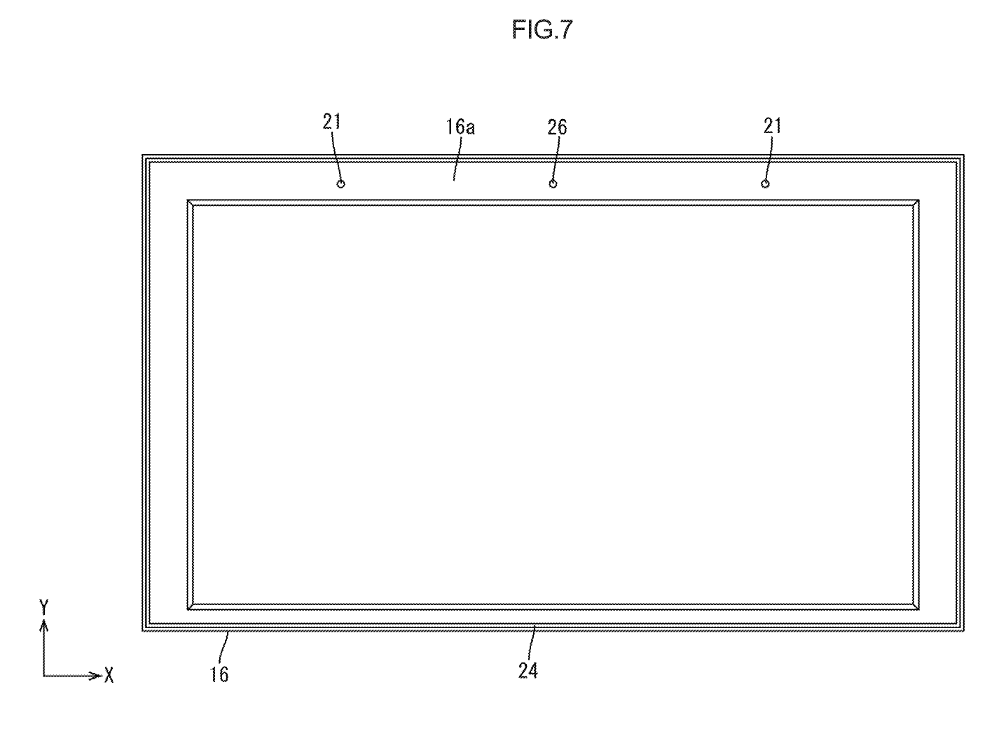

As illustrated in FIGS. 4 and 7, the frame 16 integrally includes the sheet supporter 21. Specifically, the sheet supporter 21 is included in an upper long-side section of the frame section 16a of the frame 16 with respect to the vertical direction. The sheet supporter 21 is disposed in an off-centered position and closer to an end of the upper-long-side section with respect to the horizontal direction (the second direction). A pair of sheet supporters 21 is disposed symmetrically with respect to the middle position of the upper long-side section of the frame section 16a in the horizontal direction. The sheet supporter 21 is formed in a column having a circular plan view shape and projects from the frame section 16a toward the front side. As illustrated in FIG. 6, the support section 22 projects upward from a part of the upper edge of the outer peripheral edges of the optical sheet set 15 in the vertical direction. Specifically, the support section 22 has a laterally elongated rectangular plan view shape. According to such a configuration, a cost for material of the optical sheet set 15 can be reduced compared to a configuration including the optical sheet set increased in size upwardly (vertically) over an entire lateral length thereof to form the support section. The support section 22 is included in an off-centered position and closer to an end of the upper edge (another edge side) of the optical sheet set 15 with respect to the horizontal direction. A pair of support sections 22 is disposed symmetrically with respect to the middle position of the upper edge of the optical sheet set 15 in the horizontal direction. The support section 22 has the hole 23 that is through a thickness thereof (in the Z-axis direction). The support section 22 has an outline size that is greater than a hole edge of the hole 23.

As illustrated in FIG. 5, the support section 22 includes the hole 23 and a contact section 25 at the hole edge of the hole 23. The sheet supporter 21 is to be contacted with the contact section 25 and the contact section 25 extends in a relative displacement direction in which the optical sheet set 15 thermally expands with respect to the sheet supporter 21. The contact section 25 includes middle side sections 25a and edge side sections 25b that are continuously formed. The middle side sections 25a and the edge side sections 25b are disposed close to the middle position and the edges of the optical sheet set 15 in the horizontal direction, respectively. The edge side sections 25b extend substantially straight in the horizontal direction. Therefore, an inclination angle of the edge side sections 25b with respect to the horizontal direction is zero. The middle side sections 25a extends from the respective edge side sections 25b toward the lower edge (one edge side, LEDs 17) with respect to the vertical direction. Namely, the middle side sections 25a extend obliquely with respect to the vertical direction and the horizontal direction. The middle side sections 25a have an inclination angle with respect to the horizontal direction greater than that of the edge side sections 25b. A pair of contact sections 25 are opposite each other and have the sheet supporter 21 therebetween. Namely, the hole 23 has an opening width that is substantially equal to an outer dimension diameter of the sheet supporter 21.

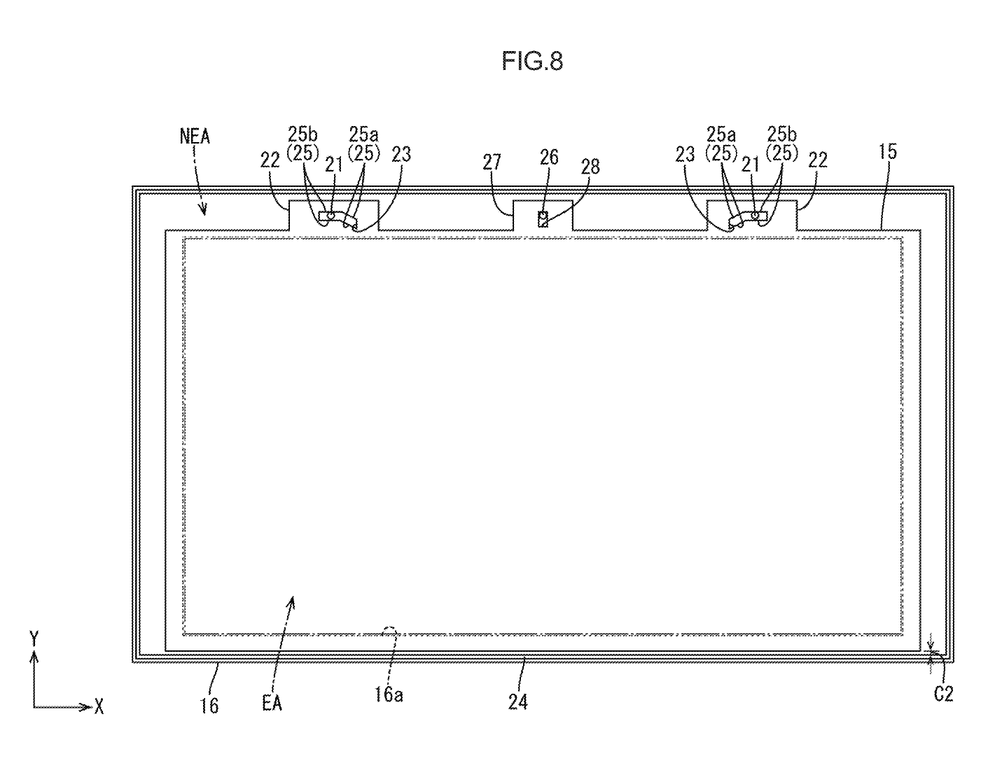

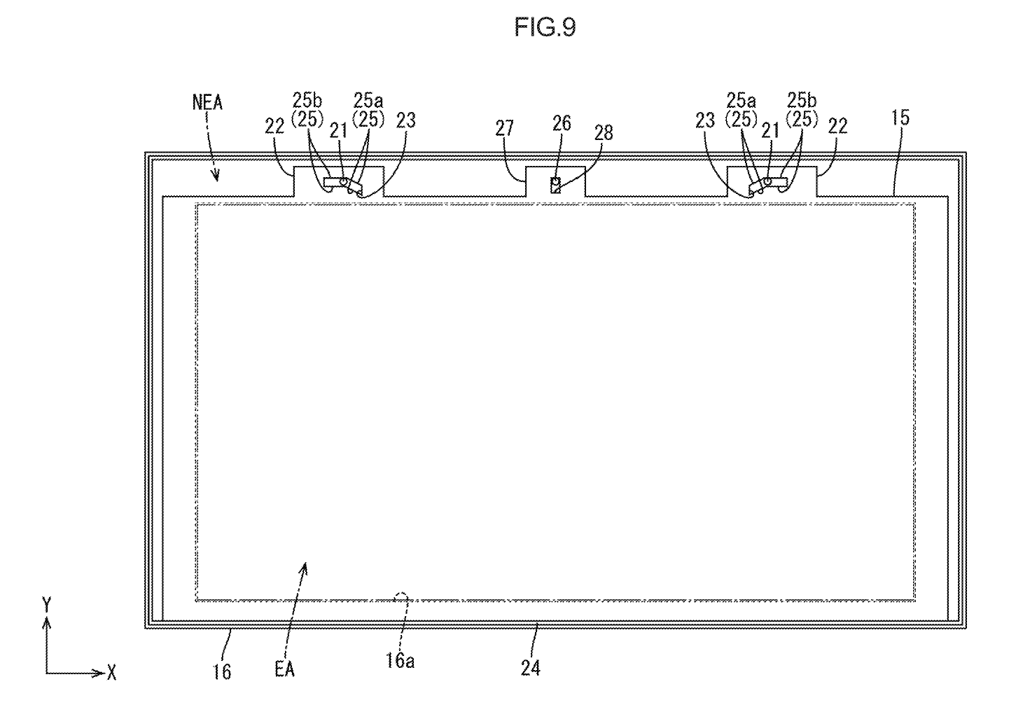

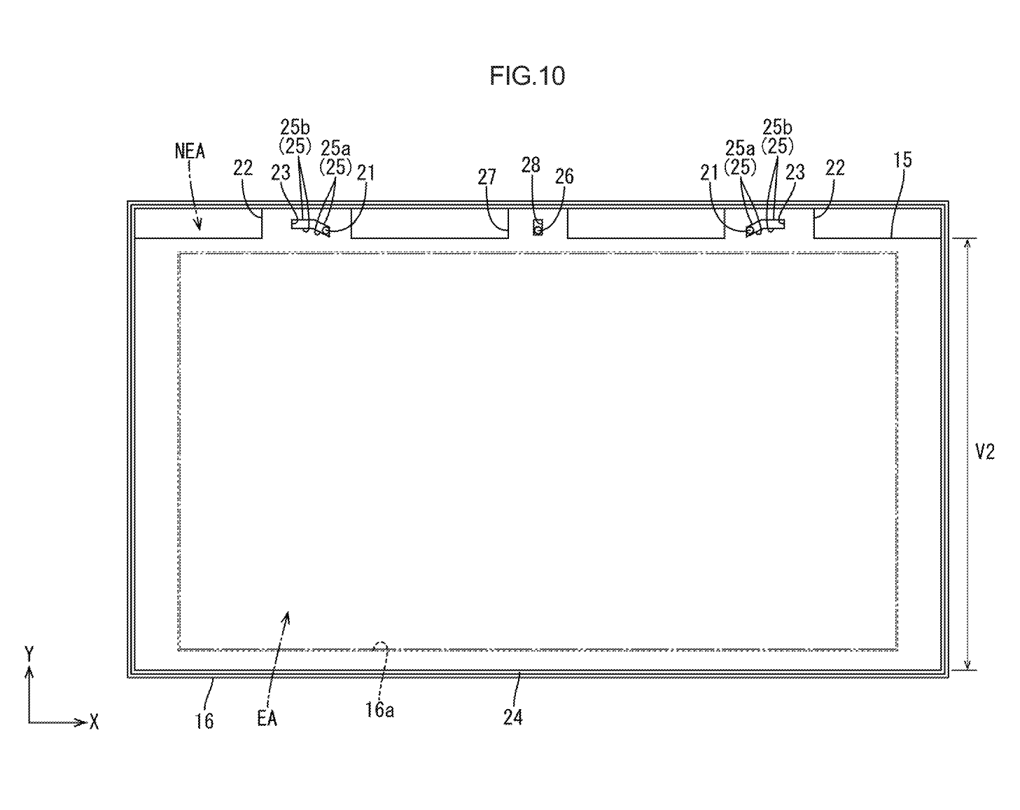

If the optical sheet set 15 thermally expands and is elongated along a surface plane thereof, the sheet supporter 21 that is contacted with the edge side sections 25b of the contact section 25 relatively moves and is contacted with the middle side section 25a. Specifically, if the optical sheet set 15 keeps thermally expanding while the edge side sections 25b being contacted with the sheet supporter 21, sheet supporter 21 is guided along, edge side sections 25b that extend in the horizontal direction without positions thereof in the vertical direction. Therefore, the optical sheet set 15 expands only downward such that the lower edge thereof in the vertical direction moves 7 from the upper edge. The upper edge of the optical sheet set 15 does not expand upwardly and the upper edge thereof does not move away from the lower edge. Refer FIGS. 5 and 8. If the optical sheet set 15 keeps thermally expanding while the middle side sections 25a being contacted with the sheet supporter 21, the sheet supporter 21 is guided along the middle side sections 25a that extend obliquely toward an opposite side from the edge side sections 25b and downwardly (toward the one edge side) in the vertical direction. Accordingly, the optical sheet set 15 expands upward such that the upper edge thereof in the vertical direction moves away from the lower edge. Refer FIGS. 9 and 10. During such expansion, the sheet supporter 21 is held by and contacted with the opposite contact sections 25 such that the support sections 22 relatively moves with respect to the sheet supporters 21 in a smooth manner according to the thermal expansion of the optical sheet set 15. Thus, deformation such as wrinkles or warping is less likely to be caused in the optical sheet set 15 according to the thermal expansion and the optical sheet set 15 expands at the upper edge section and the lower edge section thereof if the optical sheet set 15 thermally expands in the vertical direction. Therefore, compared to a configuration in which the optical sheet expands only at the lower edge section according to the thermal expansion in the vertical direction, the frame width of at least one edge side can be decreased. Therefore, the width dimension of the frame can be preferably decreased. If the frame width dimension is decreased, the light emitted by the LEDs 17 may not enter the optical sheet set 15 and is likely to leak outside without passing through the optical sheet set 15. In a relatively low temperature environment, the sheet supporter 21 is contacted with the edge side sections 25b of the contact section 25, and the optical sheet set 15 thermally expands such that the lower edge section moves away from the upper edge section in the vertical direction. Therefore, even if the frame width is decreased, the light from the LEDs 17 that are disposed on the lower edge side of the optical sheet set 15 in the vertical direction is less likely to leak without entering the optical sheet set 15. Namely, the light leaking is less likely to be caused while reducing the frame width.

As illustrated in FIG. 5 the contact section 25 is formed such that a tangent of the inclination angle of the middle side section 25a with respect to the horizontal direction is equal to a ratio of a distance between the middle position of the optical sheet set 15 in the horizontal direction and the support section 22 to a vertical dimension of the optical sheet set 15. Namely, the middle side sections 25a are configured to satisfy a formula of tan θ1=V1/D1. In the formula, θ1 is an inclination angle of the middle side sections 25a with respect to the horizontal direction, D1 is a distance between the middle position of the optical sheet set 15 in the horizontal direct on and the support section 22, and V1 is a vertical dimension of the optical sheet set 15. The sheet supporter 21 that is in contacted with the middle side sections 25a is guided by the middle side sections 25a and relatively moves in the vertical direction and the horizontal direction by a displacement amount according to the thermal expansion of the optical sheet set 15. The support section 22 moves in the vertical direction and the horizontal direction by a displacement amount according to the thermal expansion of the optical sheet set 15. According to the above configuration, the displacement amount of the sheet supporter 21 is substantially equal to the displacement amount of the support section 22. Therefore, the optical sheet set 15 expands upwardly such that the upper edge moves farther away from the lower edge in the vertical direction and the optical sheet set 15 is less likely to expand downwardly and the lower edge thereof is less likely to move farther away from the upper edge.

Furthermore, as illustrated in FIG. 5, the backlight unit 12 includes a sheet receiving section 24 that is configured to receive the lower edge section (on the opposite side from the sheet supporter 21 in the vertical direction such that the sheet receiving section 24 and the sheet supporter 21 hold the optical sheet set 15 therebetween) of the optical sheet set 15 in the vertical direction. A clearance C1 is provided between the sheet receiving section 24 and the lower edge section of the optical sheet set 15 in the vertical direction in the relatively low temperature environment (a lowest temperature environment). The lower edge section of the optical sheet set 15 in the vertical direction is contacted with the sheet receiving section 24 when the optical sheet set 15 thermally expands in a relatively high temperature environment (a second normal temperature environment) (refer FIG. 9). According to such a configuration, if the optical sheet set 15 thermally expands toward the lower side such that the lower edge section thereof in the vertical direction moves farther away from the upper edge section, the lower edge section is received by the sheet receiving section 24 and the optical sheet set 15 is less likely to expand further toward the lower side and is supported in the expansion direction. If the optical sheet set 15 thermally expands further, the optical sheet set 15 expands toward an upper side such that the upper edge section thereof in the vertical direction moves farther away from the lower edge section. Thus, the optical sheet set 15 is supported by the sheet supporter 21 and the sheet receiving section 24 at the upper edge section and the lower edge section, respectively, in the vertical direction. Therefore, the optical sheet set 15 is supported stably and the upward expansion is guided.

As illustrated in FIGS. 4 and 7, the frame 16 integrally includes the sheet receiving section 24 and the sheet supporters 21. Since the frame 16 integrally includes the sheet supporters 21 and the sheet receiving section 24, the sheet supporters 21 and the sheet receiving section 24 are positioned with high arrangement accuracy and the number of components is reduced.

As illustrated in FIG. 7, the sheet receiving section 24 is included in at least a lower long-side section of the frame section 16a of the frame 16 in the vertical direction. Specifically, the sheet receiving section 24 extends over the lower long-side section of the frame section 16a with respect to the vertical direction and further extends along the pair of short-side sections and the upper long-side section. The sheet receiving section 24 is formed in a frame shape extending over entire periphery of the frame section 16a. The sheet receiving section 24 is on the outer peripheral edge section of the frame section 16a and projects from the frame section 16a toward the front side. The sheet receiving section 24 receives the outer edge section of the liquid crystal panel 11 at a projecting end portion thereof from a back side (see FIG. 4). The sheet receiving section 24 of a frame shape includes the lower edge section with respect to the vertical direction that is opposite the lower edge section of the optical sheet set 15 in the vertical direction. As illustrated in FIG. 6, a clearance C1 is provided between the lower edge section of the sheet receiving section 24 and the lower edge section of the optical sheet set 15 in the relatively low temperature environment (a lowest temperature environment or a first normal temperature environment). The lower edge section of the sheet receiving section 24 is contacted with the lower edge section of the optical sheet set 15 in the relatively high temperature environment (a second normal temperature environment or a highest temperature environment) (refer FIG. 9). The side edge sections of the frame-shaped sheet receiving section 24 with respect to the horizontal direction (the X-axis direction, the second direction) are spaced from the vertical side edge sections of the optical sheet set 15 in the relatively low temperature environment. However, the side sections of the sheet receiving section 24 with respect to the horizontal direction are contacted with the side sections of the optical sheet set 15 in the relatively high temperature environment (a highest temperature environment) (see FIG. 10)

Next, design of specific dimensions will be described. As illustrated in FIG. 5, the sheet receiving section 24 is designed such that the clearance C1 provided between the lower edge section thereof and the lower edge section of the optical sheet set 15 in a supposed lowest temperature environment is smaller than dimension difference of dimensions of the optical sheet set 15 in the lowest temperature environment and a supposed highest temperature environment. The dimension difference is difference (V2−V1) between a short-side dimension V1 of the optical sheet set 15 in the lowest temperature environment illustrated in FIG. 5 and a short-side dimension V2 of the optical sheet set 15 in the highest temperature environment illustrated in FIG. 10. The support section 22 is designed such that a formula of V3=(V2−V1)−C1 is satisfied in relation to a vertical dimension V3 of the hole 23. In the formula, the vertical dimension V3 of the hole 23 is equal to difference between the dimension difference (V2−V1) and the clearance C1. The dimension difference (V2−V1) is difference of the vertical dimensions of the optical sheet set 15 in the lowest temperature environment and the highest temperature environment. The clearance C1 is a clearance provided between the lower edge section of the optical sheet set 15 and the sheet receiving section 24 in a supposed lowest temperature environment. Namely, a total of the vertical dimension V3 of the hole 23 and the clearance C1 provided between the lower edge section of the optical sheet set 15 and the sheet receiving section 24 is equal to the dimension difference (V2−V1) between the vertical dimensions of the optical sheet set 15 in the lowest temperature environment and the highest temperature environment. According to such a configuration, the optical sheet set 15 is allowed to thermally expand at both of the upper edge and the lower edge in the vertical direction from the lowest temperature environment to the highest temperature environment. Therefore, the deformation such as wrinkles or warping is less likely to be caused in the optical sheet set 15 according to the thermal expansion. Further, a vertical area of the hole 23 in the support section 22 can be smallest and therefore, the support section 22 is reduced in size and the frame width can be further decreased.

As illustrated in FIG. 5, the frame 16 and the optical sheet set 15 include a middle sheet supporter 26 and a middle support section 27, respectively, at middle positions thereof in the horizontal direction. The middle sheet supporter 26 disposed on a middle section of the upper long-side section of the frame section 16a of the frame 16 in the horizontal direction. Therefore, a distance between the middle sheet supporter 26 and each of the sheet supporters 21 is substantially equal. The middle support section 27 projects upwardly from a part of the upper edge of the peripheral edge of the optical sheet set 15 with respect to the vertical direction. Namely, the middle support section projects similarly to the support section 22 projects. According to such a configuration, the support sections 22 are arranged in an arrangement space provided for the middle support section 27. Therefore, the optical sheet set 15 can be decreased in size in the horizontal direction compared to a configuration including the support section projecting from the outer edge of the optical sheet set 15 in the horizontal direction. The middle support section 27 has a laterally elongated rectangular plan view shape. The optical sheet set 15 includes the middle support section 27 at a middle position of the upper edge section thereof in the horizontal direction. Therefore, a distance between the middle support section 27 and each of the support sections 22 is substantially equal. The middle support section 27 has a middle hole (a hole) 26 that is through the thickness thereof and through which the middle sheet supporter 26 is inserted. The middle hole 28 extends substantially straight in the vertical direction and the vertical dimension thereof is greater than that of the middle sheet supporter 26. According to such a configuration, the optical sheet set 15 is supported at the upper edge section thereof in the vertical direction by the middle sheet supporter 26 that is inserted through the hole 28 of the middle support section 27. If the optical sheet set 15 thermally expands, the middle support section 27 that is disposed in the middle section or the optical sheet set 15 with respect to the horizontal direction relatively moves only in the vertical direction with respect to the middle sheet supporter 26. The middle hole 28 in the middle support section 27 extends vertically and has a vertical dimension that is greater than that of the middle sheet supporter 26. Therefore, the middle hole 28 allows the relative movement of the middle support section 27. The middle hole 28 has hole edges including a pair of vertical hole edges. The pair of vertical hole edges sandwich the middle sheet supporter 26 from both sides in the horizontal direction and are contacted with the middle sheet supporter 26. Therefore, relative movement of the middle sheet supporter 26 and the middle support section 27 is smoothly guided.

The present embodiment has the above-described configuration and operations thereof will be described. If the power of the liquid crystal display device 10 having the above configuration is turned on, driving of the liquid crystal panel 11 is controlled by a control circuit and driving power is supplied to each of the LEDs 17 on the LED board 18 from a LED drive circuit to control driving of the LEDs 17. As illustrated in FIG. 4, the light emitted by the LEDs 17 travels within the light guide plate 19 and exits through the optical sheet set 15 and is supplied to the liquid crystal panel 11. Thus, a certain image is displayed on the liquid crystal panel 11.

When the liquid crystal display device 10 is used, the LEDs 17 are lighted on and generates heat and various kinds of boards arranged on the back side of the backlight unit 12 generate heat. Furthermore, external environment temperature (room temperature if the device is used inside and outside temperature if the device is used outside) may be increased. If the temperature is increased, components of the liquid crystal display device 10 may thermally expand. Particularly, the optical sheet set 15 that is a large and thin optical member tends to thermally expand greatly and is likely to be deformed to have wrinkles or warping by the thermal expansion and the optical performance is likely to be deteriorated. In this embodiment, the sheet support structure that allows thermal expansion of the optical sheet set 15 and supports the optical sheet set 15 vertically. Hereinafter, the operations will be described in detail.

According to this embodiment, in the external environment temperature, a normal temperature is 25° C., a low temperature is 0° C., and a high temperature is 50° C., for example. If the external environment temperature is the low temperature and the backlight unit 12 is not lighted on, the external temperature environment is a supposed lowest temperature environment. If the external environment temperature is the high temperature and the backlight unit 12 is lighted on at highest brightness, the external temperature environment is a supposed highest temperature environment. If the external environment temperature is the normal temperature and the backlight unit 12 is not lighted on, the external temperature environment is a first normal temperature environment. If the external environment temperature is the normal temperature and the backlight unit 12 is lighted on at the highest brightness, the external temperature environment is a second normal temperature environment. The first normal temperature environment and the second normal temperature environment: are normal (general) situation where the device is supposed to be used for long time. The temperature environment closer to the lowest temperature environment than the first normal temperature and the temperature environment closer to the highest temperature environment than the second normal temperature are temporary situation that is not a normal situation. FIG. 5 illustrates the lowest temperature environment, FIG. 8 illustrates the first normal temperature environment, FIG. 9 illustrates the second normal temperature environment, and FIG. 10 illustrates the highest temperature environment.

First, using of the liquid crystal display device 10 starts in the lowest temperature environment and if the backlight unit 12 is lighted on, internal temperature of the liquid crystal display device 10 is increased due to the heat generated by the LEDs 17 and the optical sheet set 15 thermally expands. If the liquid crystal display device 10 is not used in the lowest temperature environment and the external environment temperature is increased from 0° C., the internal temperature of the liquid crystal display device 10 is increased and the optical sheet set 15 thermally expands. In either case, if the optical sheet set thermally expands in the lowest temperature environment illustrated in FIG. 5, the lower edge section of the optical sheet set 15 with respect to the vertical direction moves toward the lower side with the support sections 22 and the middle support section 27 (upper edge side) that are supported by the sheet supports 21 and the middle sheet support 26 being used as the fixed points and approaches the sheet receiving section 24, and the two edge sections of the optical sheet set 15 with respect to the horizontal direction move laterally with the middle support section 27 being used as the fixed point. Thus, the optical sheet set 15 does not expand upwardly and expands downwardly in the vertical direction because of the configuration of the contact section 25 as described below. The edge side sections 25b of the contact section 25 of each support section 22 extends horizontally and does not vertically change a position thereof. According to such a configuration, each support section 22 relatively moves such that each sheet supporter 21 is relatively guided along the edge side sections 25b. Accordingly, the clearance C1 between the lower edge section of the optical sheet set 15 and the sheet receiving section 24 is gradually reduced.

If the external environment temperature is increased from the lowest temperature environment to the normal temperature (25° C.) without using the liquid crystal display device 10, the external environment is in the first normal temperature environment. As illustrated in FIG. 8, in the first normal temperature environment, each of the sheet supporters 21 is positioned at a middle of the edge side sections 25b of each contact section 25 extending horizontally. A clearance C2 is provided between the lower edge section of the optical sheet set 15 and the sheet receiving section 24 with respect to the vertical direction and the clearance C2 is smaller than the clearance C1 provided in the lowest temperature environment. The lower edge section is not in contact with the sheet receiving section 24. From the first normal temperature environment, if the liquid crystal display device 10 is started to be used and the backlight unit 12 is lighted on at the highest brightness, the temperature environment is changed to the second normal temperature environment. If the temperature environment is changed from the normal temperature environment to the second normal temperature environment, each of the sheet supporters 21 is positioned at a border between the horizontally extending edge side section 25b and the obliquely extending middle section 25a of each contact section 25 as illustrated in FIG. 9. The lower edge section of the optical sheet set 15 in the vertical direction is in contact with the sheet receiving section 24. The lower edge section of the optical sheet set 15 in the vertical direction is received by the sheet receiving section 24 such that the optical sheet set 15 is less likely to expand further toward the lower side in the vertical direction. The lower edge section of the optical sheet set 15 is contacted with the sheet receiving section 24 in the second normal temperature environment that is lower than the highest temperature environment since the clearance C1 provided between the lower edge section of the optical sheet set 15 and the sheet receiving section 24 in the lowest temperature environment is smaller than the vertical dimension difference (V2−V1) between the dimensions of the optical sheet set 15 in the lowest temperature environment and the highest temperature environment. While the temperature environment is changed from the first normal temperature environment to the second normal temperature environment, the display device is supposed to be used for a long time, and during such a period, the lower edge section of the optical sheet set 15 in the vertical direction is not received by the sheet receiving section 24. Therefore, problems that may be caused by contact of the optical sheet set 15 and the sheet receiving section 24 (abnormal noise) are less likely to be caused under the normal using situation.

If the external environment temperature is increased to the high temperature (50° C.) from the second normal temperature environment while keeping the backlight unit 12 being lighted on at the highest brightness, the temperature environment is in the highest temperature environment. If the optical sheet set 15 thermally expands further according to the increase of the external temperature from the second normal temperature environment, the sheet supporter 21 is relatively guided along the middle side section 25a and relatively moves toward an end opposite from the edge side section 25b. The middle side section 25a extends obliquely with respect to the vertical direction and the horizontal direction and extends downwardly with respect to the vertical direction and toward an opposite side from the edge side section 25b. According to the relative sliding of the sheet supporter 21 along, the middle side section 25a, the optical sheet set 15 can expand upward at the upper edge section thereof with respect to the vertical direction. Particularly, the middle side section 25a is formed such that a tangent of the inclination angle θ1 with respect to the horizontal direction is equal to a ratio of a distance D1 between the middle position of the optical sheet set 15 in the horizontal direction and the support section 22 to the vertical dimension V1 of the optical sheet set 15. The sheet supporter 21 that is in contacted with the middle side sections 25a is guided by the middle side sections 25a and relatively moves in the vertical direction and the horizontal direction by a displacement amount according to the thermal expansion of the optical sheet set 15. The support section 22 moves in the vertical direction and the horizontal direction by a displacement amount according to the thermal expansion of the optical sheet set 15. According to the above configuration, the displacement amount of the sheet supporter 21 is substantially equal to the displacement amount of the support section 22. Therefore, the optical sheet set 15 does not expand downwardly and expands upwardly with respect to the vertical direction. The middle sheet supporter 26 relatively moves downwardly with respect to the vertical direction within the middle hole 28 of the middle support section 27. As described before, the optical sheet set 15 is received by the sheet receiving section 24 at the lower edge section thereof so as not to expand downward with respect to the vertical direction.

The optical sheet set 15 is allowed to thermally expand upwardly at the upper edge thereof from the second normal temperature environment to the highest temperature environment illustrated in FIG. 10. Therefore, the deformation such as wrinkles or warping is less likely to be caused in the optical sheet set 15 according to the thermal expansion. If the temperature environment is changed from the second normal temperature environment to the highest temperature environment, the optical sheet set 15 expands to the largest size within the assumed range with respect to the vertical direction and the horizontal direction as illustrated in FIG. 10. The sheet supporters 21 and the middle sheet supporter 26 reach the respective lower edges of the holes 23 and the middle hole 28 of the support sections 22 and the middle support section 27. The side sections of the optical sheet set 15 with respect to the horizontal direction are contacted with the side sections of the sheet receiving section 24. The sheet supporters 21 and the middle sheet supporter 26 reach the respective lower edges of the holes 23 and the middle hole 28 of the support sections 22 and the middle support section 27 in the highest temperature environment because the support section 22 and the middle support section 27 are designed such that the vertical dimension V3 of the hole 23 and the middle hole 28 of each support section 22 and the middle support section 27 is equal to difference between the dimension difference (V2−V1) and the clearance C1. The dimension difference (V2−V1) is difference of the vertical dimension of the optical sheet set 15 in the lowest temperature environment and the highest temperature environment. The clearance C1 is a clearance provided between the lower edge section of the optical sheet set 15 and the sheet receiving section 24 in the lowest temperature environment. If the optical sheet set 15 thermally contracts, the sheets supporter 21 and the support section 22 relatively move in the opposite direction from the above description and the deformation such as wrinkles or warping is less likely to be caused in the optical sheet set 15.

As described before, the backlight unit (the lighting device) 12 of the present embodiment includes the optical sheet set 15, the LEDs (the light source) 17, the sheet supporter 21, the support section 22, and the contact section 25. The optical sheet set 15 has a surface along the first direction and the second direction that are perpendicular to each other and adds specific optical effects to the light. The LEDs 17 are arranged on one edge side of the optical sheet set 15 in the first direction. The sheet supporter 21 supports the other edge section of the optical sheet set 15 with respect to the first direction. The support section 22 is included in an edge side section of the other edge section of the optical sheet set 15 with respect to the middle section in the second direction and supported by the sheet supporter 21. The contact section 25 is included in the support section 22 and to be contacted with the sheet supporter 21. The contact section 25 includes the middle side section 25a on a middle side and the edge side section 25b on an edge side with respect to the second direction and the middle side section 25a is continuous to the edge side section 25b. At least the middle side section 25a extends obliquely with respect to the first direction and the second direction and extends from the edge side section 25b toward the one edge side with respect to the first direction. The inclination angle θ1 of the middle side section 25a with respect to the second direction is greater than that of the edge side section 25b.

According to such a configuration, the light emitted by the LEDs 17 that are arranged on the one edge side of the optical sheet set 15 in the first direction is supplied to the surface of the optical sheet set 15 parallel to the first direction and the second direction. Then, the optical effects are added to the light by the optical sheet set 15. The optical sheet set 15 is supported by the sheet supporter 21 that is contacted with the contact section 25 of the support section 22 in the first direction. The support section 22 is included on the other edge side of the optical sheet set 15 in the first direction and on edge side with respect to the middle section in the second direction. The optical sheet set 15 thermally expands in the first direction and the second direction according to the increase of the temperature. Accordingly, the sheet supporter 21 that is contacted with the edge side section 25b of the contact section 25 relatively moves to be contacted with the middle side section 25a. Specifically, first, in the relatively low temperature environment, the sheet supporter 21 is contacted with the edge side section 25b of the contact section 25 of the support section 22 included in the optical sheet set 15. The edge side section 25b has an inclination angle with respect to the second direction smaller than that of the middle side section 25a. Therefore, if the optical sheet set 15 thermally expands according to the increase of the environment temperature, the sheet supporter 21 is guided along the edge side section 25b and the optical sheet set 15 expands such that the one edge side section thereof in the first direction moves farther away from the other edge section in the first direction.

According to the thermal expansion of the optical sheet set 15, an object that is to be contacted with the sheet supporter 21 is shifted from the edge side section 25b to the middle side section 25a of the contact section 25. The middle side section 25a extends obliquely with respect to the first direction and the second direction and extends from the edge side section 25b toward the one edge side with respect to the first direction. The inclination angle θ1 of the middle side section 25a with respect to the second direction is greater than that of the edge side section 25b. According to such a configuration, if the optical sheet set 15 thermally expands according to the further increase of the temperature, the sheet supporter 21 is guided along the middle side section 25a and the optical sheet set 15 expands such that the other edge section thereof in the first direction moves farther away from the one edge section in the first direction. Accordingly, the deformation such as wrinkles or warping is less likely to be caused in the optical sheet set 15 according to the thermal expansion.

The optical sheet set 15 expands at the one edge section and the other edge section thereof if the optical sheet set 15 thermally expands in the first direction. Therefore, compared to a configuration in which the optical sheet expands only at the one edge section according to the thermal expansion in the first direction, the frame width of at least one edge side can be decreased. Accordingly, the width dimension of the frame can be preferably decreased. According to the decrease of the frame width dimension, the light emitted by the LEDs 17 may not enter the optical sheet set 15 and is likely to leak outside without passing through the optical sheet set 15. In a relatively low temperature environment, the sheet supporter 21 is contacted with the edge side section 25b of the contact section 25 and the optical sheet set 15 thermally expands such that the one edge section moves away from the other edge section in the first direction. Therefore, even if the frame width is decreased, the light from the LEDs 17 that are disposed on the one edge side of the optical sheet set 15 in the first directions is less likely to leak without entering the optical sheet set 15. Namely, the light leaking is less likely to be caused while reducing the frame width.

The contact section 25 is formed such that the middle side section 25a has a tangent of the inclination angle θ1 with respect to the second direction is equal to a ratio of the distance D1 between the middle position of the optical sheet set 15 in the second direction and the support section 22 to the dimension V1 of the optical sheet set 15 in the first direction. According to such a configuration, if the optical sheet set 15 thermally expands further while the sheet supporter 21 being contacted with the middle side section 25a, the sheet supporter 21 is guided along the middle side section 25a and the optical sheet set 15 expands such that the other edge section in the first direction moves farther away from the one edge section in the first direction and does not expand at the one edge section thereof to be away from the other edge section.

The contact section 25 is formed such that the edge side section 25b extends in the second direction. According to such a configuration, if the optical sheet set 15 thermally expands while the sheet supporter 21 being contacted with the edge side section 25b, the sheet supporter 21 slides along the edge side section 25b and the optical sheet set 15 expands such that the one edge section in the first direction moves farther away from the other edge section in the first direction and does not expand at the other edge section to be farther away from the one edge section.

The optical sheet set 15 includes the middle support section 27 at the middle position of the other edge section thereof in the second direction. The middle sheet supporter 26 supports the middle support section 27. The middle support section 27 has the middle hole (the hole) 28 through which the middle sheet supporter 26 is inserted. The middle hole 28 has a dimension in the first direction that is greater than that of the middle sheet supporter 26. According to such a configuration, the optical sheet set 15 is supported at the other edge section thereof in the first direction by the middle sheet supporter 26 that is inserted through the middle hole 28 of the middle support section 27. The middle support section 27 is included in the middle position of the optical sheet set 15 in the second direction. If the optical sheet set 15 thermally expands, the middle support section 27 relatively moves in the first direction with respect to the middle sheet supporter 26. The middle hole 28 in the middle support section 27 extends in the first direction and has a dimension in the first direction that is greater than that of the middle sheet supporter 26. Therefore, the middle hole 28 allows the relative movement of the middle support section 27.

The backlight unit 12 includes the sheet receiving section 24 that is configured to receive the one edge section of the optical sheet set 15 in the first direction. The one edge section is on the opposite side from the sheet supporter 21 in the first direction such that the sheet receiving section 24 and the sheet supporter 21 hold the optical sheet set 15 therebetween. A clearance is provided between the sheet receiving section 24 and the one edge section of the optical sheet set 15 in the relatively low temperature environment and the one edge section of the optical sheet set 15 is contacted with the sheet receiving section 24 in the relatively high temperature environment. According to such a configuration, if the optical sheet set 15 thermally expands such that the one edge section thereof in the first direction moves farther away from the other edge section in the first direction, the one edge section is received by the sheet receiving section 24 and the optical sheet set 15 is less likely to expand further at the one edge section and is supported in the first direction. If the optical sheet set 15 thermally expands further, the optical sheet set 15 expands such that the other edge section thereof in the first direction moves farther away from the one edge section. Thus, the optical sheet set 15 is supported by the sheet supporter 21 and the sheet receiving section 24 at the one edge section and the other edge section in the first direction. Therefore, the optical sheet set 15 is supported stably.

The backlight unit 12 includes the frame 16 that extends in a frame shape along the outer edge of the optical sheet set 15. The frame 16 includes the sheet receiving section 24 and the sheet supporters 21. Since the frame 16 includes the sheet supporters 21 and the sheet receiving section 24, the sheet supporters 21 and the sheet receiving section 24 are positioned with high arrangement accuracy and the number of components is reduced.

Two contact sections 25 are arranged opposite each other and have the sheet supporter 21 therebetween. According to such a configuration, the sheet supporter 21 is sandwiched by the pair of contact sections 25 that are opposite each other and is contacted with the contact sections 25. Therefore, the support section 22 relatively moves with respect to the sheet supporter 21 smoothly according to the thermal expansion of the optical sheet set 15.

The support section 22 projects from a part of the outer edge of the optical sheet set 15. According to such a configuration, the optical sheet set 15 is not increased in size as a whole and a material cost for the optical sheet set 15 can be reduced.

The backlight unit 12 includes the middle support section 27 in a middle position with respect to the second direction on the other edge section of the optical sheet set 15 and the middle sheet supporter 26 that supports the middle support section 27. The support section 22 projects from the outer edge of the optical sheet set 15 in the first direction similarly to the middle support section 27. According to such a configuration, the support section 22 can be arranged in the space provided for the middle support section 27. Therefore, compared to a configuration including the support section projecting from the outer edge of the optical sheet set 15 in the second direction, the optical sheet set 15 can be reduced in size in the second direction.

The liquid crystal display device (the display device) 10 of the present embodiment includes the above backlight unit 12 and the liquid crystal panel (the display panel) 11 displaying images with using light from the backlight unit 12. According to the liquid crystal display device 10 having the above configuration, the frame width of the backlight unit 12 is reduced and outer appearance is improved.

### Second Embodiment

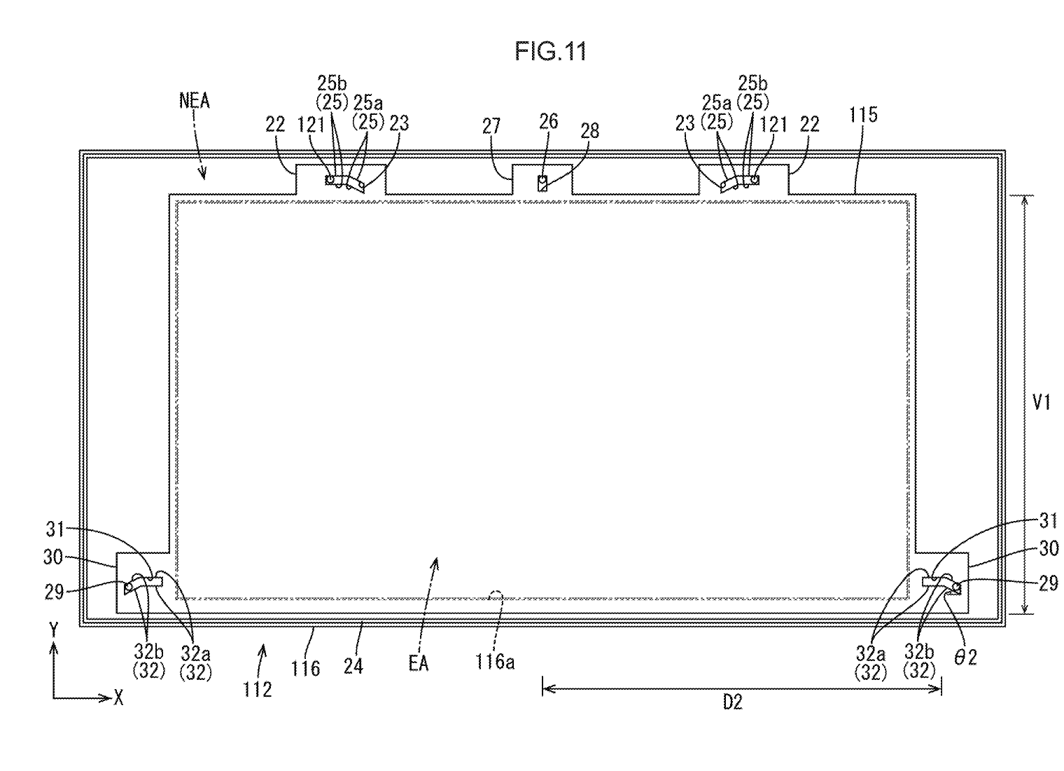

A second embodiment of the present invention will be described with reference to FIGS. 11 to 14. The second embodiment further includes a second sheet support structure. Configurations, operations, and effects similar to those in the first embodiment will not be described.

A backlight unit 112 of the present embodiment includes the sheet support structure of the first embodiment and the second sheet support structure (one edge sheet support structure, a lower edge side sheet support structure). As illustrated in FIG. 11, the second sheet support structure supports a lower edge section (one edge side) of an optical sheet set 115 in the vertical direction. The second sheet support structure includes a second sheet supporter (one edge side sheet supporter, a lower edge side sheet supporter) 29 and a second support section (one edge side support section, a lower edge side support section) 30. The second sheet supporter 29 supports the lower edge side section of the optical sheet set 115 with respect to the vertical direction. The second support section 30 is included in the lower edge section of the optical sheet set 115 with respect to the vertical direction and has a second hole (a one edge side open section, a lower edge side open section) 31 through which the second sheet supporter 29 is inserted. The second support section 30 is supported by the second sheet supporter 29 that is inserted through the second hole 31.

As illustrated in FIG. 11, the second sheet supporter 29 is integrally included in a frame 116. Specifically, the frame 116 includes the second sheet supporters 29 on two short-side edges of a frame section 116a with respect to the horizontal direction. The second sheet supporter 29 is included in a section of the short-side edge closer to the lower edge with respect to the vertical direction. The second support section 30 projects laterally in the horizontal direction from a part of the lower section of the side edge of the outer edge of the optical sheet set 115 extending in the vertical direction. Specifically, the second support section 30 has a vertically elongated rectangular plan view shape. The optical sheet set 115 includes the second support section 30 on each of the side edges thereof at each lower section. Each of the second support sections 30 has a second hole 31 that is through a thickness thereof.

As illustrated in FIG. 11, the second support section 30 includes the second hole 31 and a second contact section (a one edge side section, lower edge side section) 32 at a hole edge of the second hole 31. The second sheet supporter 29 is to be contacted with the second contact section 32 and the second contact section 32 extends in a relative displacement direction in which the optical sheet set 115 thermally expands with respect to the second sheet supporter 29. The second contact section 32 includes second middle side sections 32a and second edge side sections 32b that are continuously formed. The second middle side sections 32a and the second edge side sections 32b are disposed close to the middle section and the edges of the optical sheet set 115 in the horizontal direction, respectively. The second middle side sections 32a extend substantially straight in the horizontal direction. Therefore, an inclination angle of the second middle side sections 32a with respect to the horizontal direction is zero. The second edge side sections 32b extend obliquely with respect to the vertical direction and the horizontal direction and toward the lower edge with respect to the vertical direction from a border between the second edge side sections 32b and the respective second middle side sections 32a. The second edge side sections 32b have an inclination angle with respect to the horizontal direction greater than that of the second middle side sections 32a. Specifically, the second contact section 32 is formed such that a tangent of the inclination angle θ2 of the second edge side section 32b with respect to the horizontal direction is equal to a ratio of a distance D2 between the middle position of the optical sheet set 115 in the horizontal direction and the second support section 30 to a vertical dimension V1 of the optical sheet set 115. Namely, the second edge side sections 32b are configured to satisfy a formula of tan θ2=V1/D2. Two second contact sections 32 are provided opposite each other with sandwiching the second sheet supporter 29 therebetween. Namely, the second hole 31 has a hole width that is substantially same as an outer dimension (a diameter) of the second sheet supporter 29.

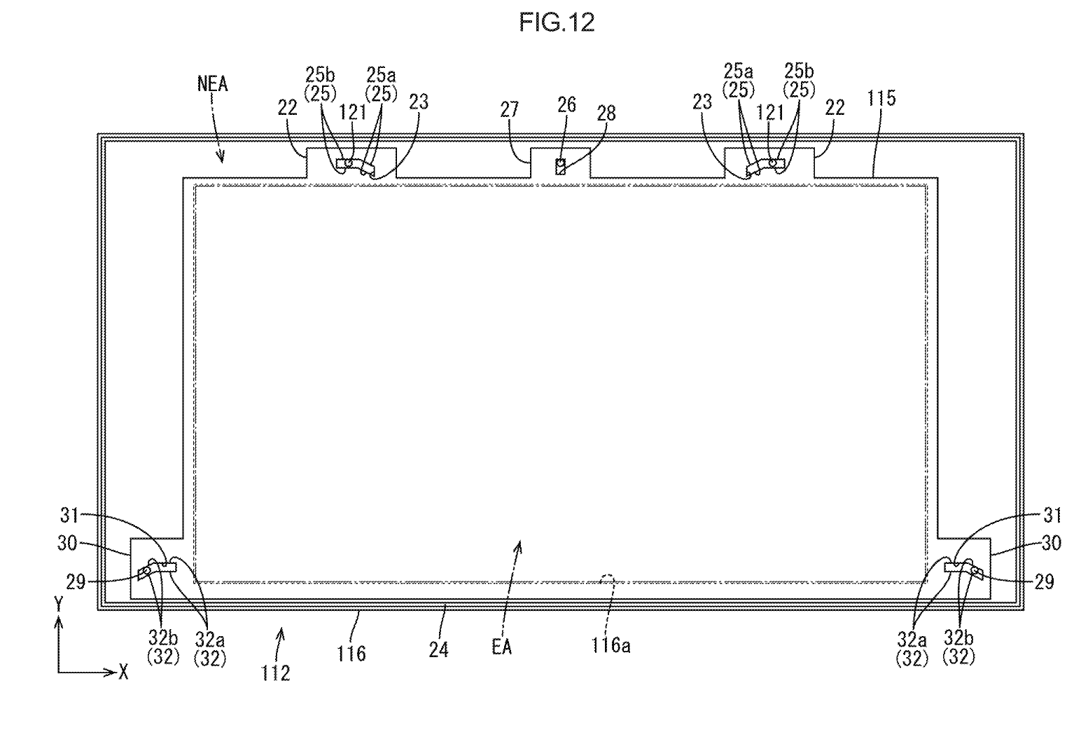

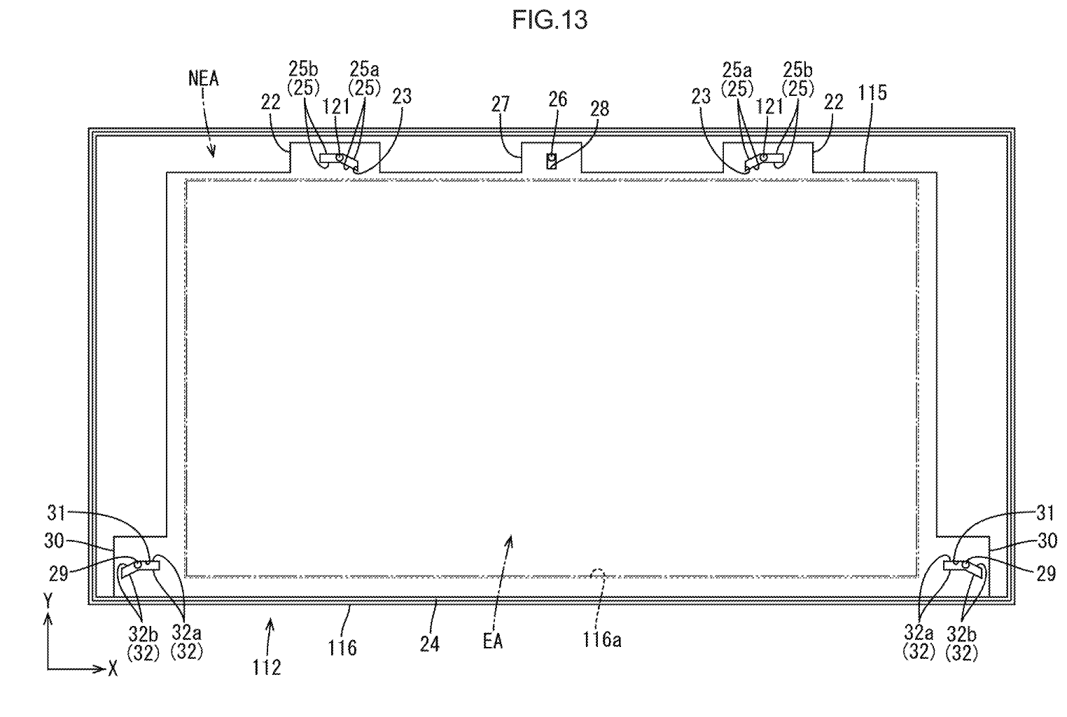

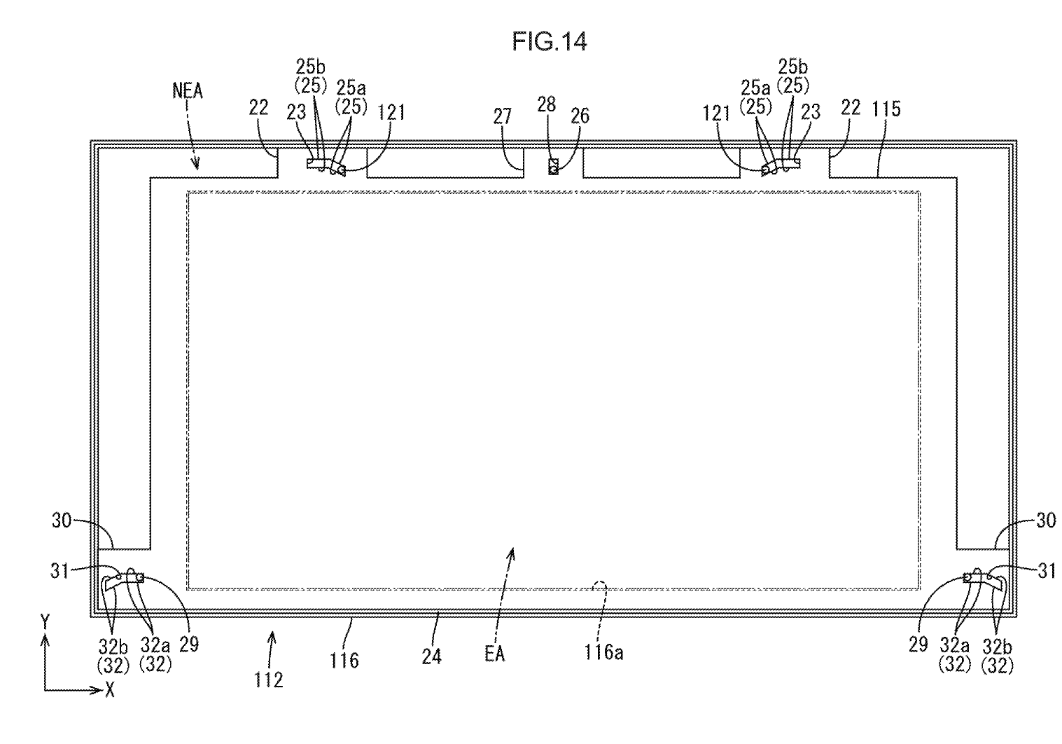

If the optical sheet set 115 thermally expands along a surface plane thereof, the second sheet supporter 29 that is contacted with the second edge side sections 32b of the second contact section 32 relatively moves and is contacted with the second middle side sections 32a. Specifically, if the optical sheet set 115 keeps thermally expanding while the second edge side sections 32b being contacted with the second sheet supporter 29, the second sheet supporter 29 is guided along the second edge side sections 32b that extend obliquely and upward (toward the other edge side) in the vertical direction toward the second middle side sections 32a. Therefore, the optical sheet set 115 expands downward such that the lower edge thereof in the vertical direction moves away from the upper edge (see FIGS. 11 and 12). During the expansion, the second sheet supporter 29 is sandwiched by the two second contact sections 32 that are opposite each other and contacted with the second contact sections 32. Therefore, the relative movement of the second support section 30 with respect to the second sheet supporter 29 is performed smoothly according to the thermal expansion of the optical sheet set 115. If the optical sheet set 115 keeps thermally expanding while the second middle side sections 32a being contacted with the second sheet supporter 29, the second sheet supporter 29 is guided along the second middle side sections 32a that extend horizontally and does not change its position in the vertical direction. Accordingly, the optical sheet set 115 expands upward such that the upper edge thereof in the vertical direction moves away from the lower edge and does not expand downward (see FIGS. 13 and 14). Thus, deformation such as wrinkles or warping is less likely to be caused in the optical sheet set 115 according to the thermal expansion and the optical sheet set 115 is supported by the sheet supporter 121 and the second sheet supporter 29 at the upper edge section and the lower edge section thereof. Therefore, the optical sheet set 115 is supported more stably.

Specific operations will be described. If the optical sheet set 115 thermally expands according to the increase of the temperature from the lowest temperature environment illustrated in FIG. 11, the optical sheet set 115 expands such that the lower edge section thereof in the vertical direction moves downward in the vertical direction and the two edge sections in the horizontal direction move laterally in the horizontal direction. During the expansion, the second sheet supporter 29 is guided along the second edge side sections 32b and the second sheet supporter 29 relatively moves along the second edge side sections 32b toward the second middle side sections 32a. The second edge side sections 32b extend obliquely with respect to the vertical direction and the horizontal direction and upward in the vertical direction toward the respective second middle side sections 32a. Therefore, the second sheet supporter 29 is guided along the second edge side sections 32b and the optical sheet set 115 expands such that the lower edge section thereof in the vertical direction moves downward in the vertical direction. Specifically, the second contact section 32 is formed such that a tangent of the inclination angle θ2 of the second edge side section 32b with respect to the horizontal direction is equal to a ratio of the distance D2 between the middle position of the optical sheet set 115 in the horizontal direction and the second support section 30 to the vertical dimension V1 of the optical sheet set 115. The second sheet supporter 29 that is in contact with the second edge side sections 32b is guided by the second edge side sections 32b and relatively moves in the vertical direction and the horizontal direction by a displacement amount according to the thermal expansion of the optical sheet set 115. The second support section 30 moves in the vertical direction and the horizontal direction by a displacement amount according to the thermal expansion of the optical sheet set 115. According to the above configuration, the displacement amount of the second sheet supporter 29 is substantially equal to the displacement amount of the second support section 30. Therefore, the optical sheet set 115 does not expand upwardly and expands downwardly with respect to the vertical direction. Next, if the temperature is increased from the first normal temperature environment to the second normal temperature environment, the second sheet supporter 29 reaches the border between the second edge side sections 32b obliquely extending and the second middle side sections 32a horizontally extending in the second contact section 32.

If the optical sheet set 115 thermally expands further according to the increase of the external temperature from the second normal temperature environment, the second sheet supporter 29 that is contacted with the second middle side sections 32a relatively waves toward an end opposite from the second edge side sections 32b with respect to the second middle side sections 32a. The second middle side sections 32a extends in the horizontal direction and does not change its position in the vertical direction. With such a configuration, according to the relative sliding of the second sheet supporter 29 along the second middle side sections 32a, the optical sheet set 115 does not expand downward and expands only upward with respect to the vertical direction.

As described before, the backlight unit of the present embodiment includes the second sheet supporter 29, the second support section 30, and the second contact section 32. The second sheet supporter 29 supports one edge side section of the optical sheet set 115. The second support section 30 is included in one edge side section of the optical sheet set 115 and supported by the second sheet supporter 29. The second contact section 32 is included in the second support section 30 and to be contacted with the second sheet supporter 29. The second contact section 32 includes the second middle side section 32a on a middle side and the second edge side section 32b on an edge side with respect to the second direction and the second middle side section 32a is continuous to the second edge side section 32b. At least the second edge side section 32b extends from the second middle side section 32a obliquely toward an opposite side from the other edge side. The inclination angle of the second edge side section 32b with respect to the second direction is greater than that of the second middle side section 32a. According to such a configuration, the optical sheet set 115 thermally expands in the first direction and the second direction according to the increase of the temperature and the second sheet supporter 29 that is contacted with the second edge side section 32b of the second contact section 32 relatively moves to be contacted with the second middle side section 32a. Specifically, first, in the relatively low temperature environment, the second sheet supporter 29 is contacted with the second edge side sections 32b of the second contact section 32 of the second support section 30 included in the optical sheet set 115. The second edge side sections 32b extend from the respective second middle side sections 32a obliquely toward the opposite side from the other edge side in the first direction. The second edge side section 32b has an inclination angle with respect to the second direction greater than that of the second middle side section 32a. Therefore, if the optical sheet set 115 thermally expands according to the increase of the environment temperature, the second sheet supporter 29 is guided along the second edge side sections 32b and the optical sheet set 115 expands such that the other edge side section thereof in the first direction moves farther away from the other edge section in the first direction. An object that is to be contacted with the second sheet supporter 29 is shifted from the second edge side section 32b to the second middle side section 32a of the second contact section 32 according to the thermal expansion of the optical sheet set 115. The inclination angle or the second middle side section 32a with respect to the second direction is smaller than that of the second edge side section 32b. According to such a configuration, if the optical sheet set 115 thermally expands according to the further increase of the temperature, the second sheet, supporter 29 is guided along the second middle side sections 32a and the optical sheet set 115 expands such that the other edge section thereof in the first direction moves farther away from the one edge section in the first direction. Accordingly, the deformation such as wrinkles or warping is less likely to be caused in the optical sheet set 115 according to the thermal expansion. As described before, the optical sheet set 115 is supported by the second sheet supporter 29 and the sheet supporter 121 at the one edge section and the other edge section thereof in the first direction. Therefore, the optical sheet set 115 is supported more stably.

The second contact section 32 is formed such that a tangent of the inclination angle θ2 of the second edge side section 32b with respect to the second direction is equal to a ratio of the distance D2 between the middle position of the optical sheet set 115 in the second direction and the second support section 30 to the dimension V1 of the optical sheet set 115 in the first direction. According to such a configuration, if the optical sheet set 115 thermally expands further while the second sheet supporter 29 being contacted with the second edge side section 32b, the second sheet supporter 29 is guided by the second edge side section 32b and the optical sheet set 115 expands such that the one edge section in the first direction moves farther away from the other edge section in the first direction and does not expand at the other edge section thereof to be away from the one edge section.

The second contact section 32 is formed such that the second middle side section 32a extends in the second direction. According to such a configuration, if the optical sheet set 115 thermally expands while the second sheet supporter 29 being contacted with the second middle side section 32a, the second sheet supporter 29 is guided by the second middle side section 32a. Accordingly, the optical sheet set 115 expands such that the other edge section in the first direction moves away from the one edge section in the first direction and does not expand at the one edge section to be away from the other edge section.

### Third Embodiment

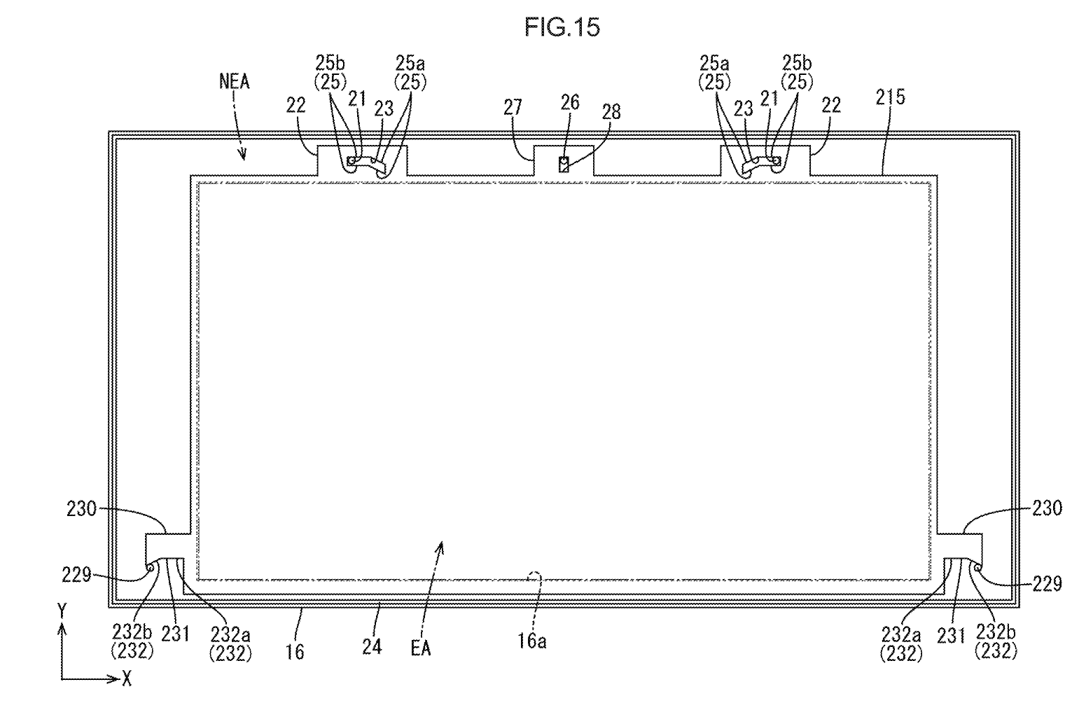

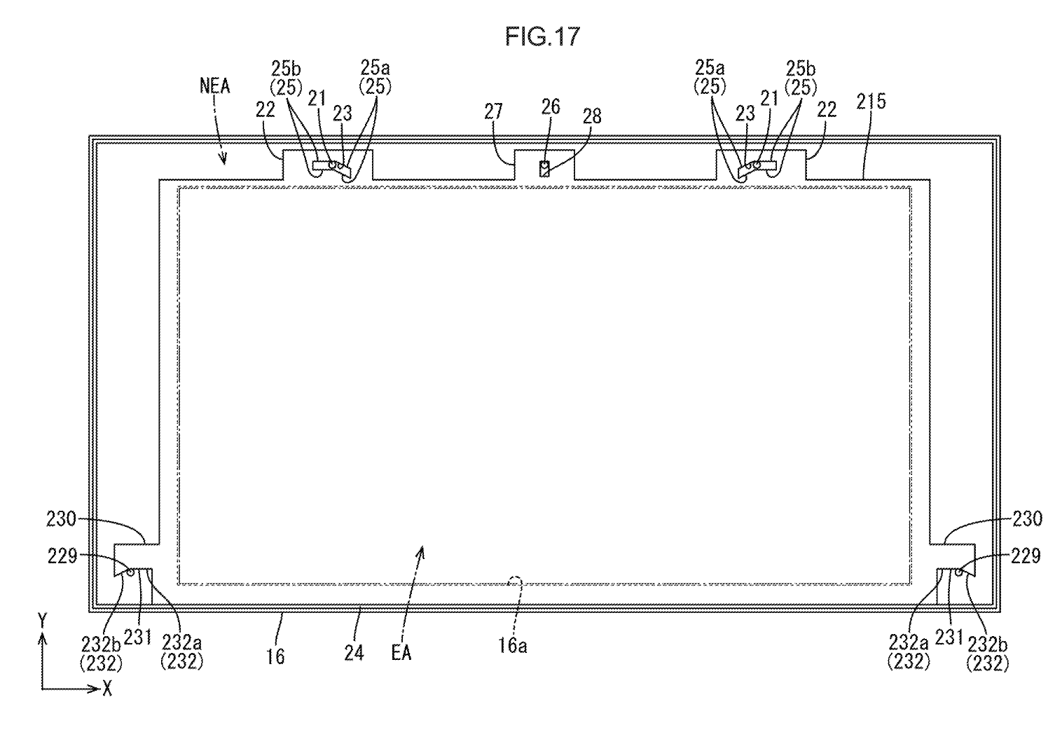

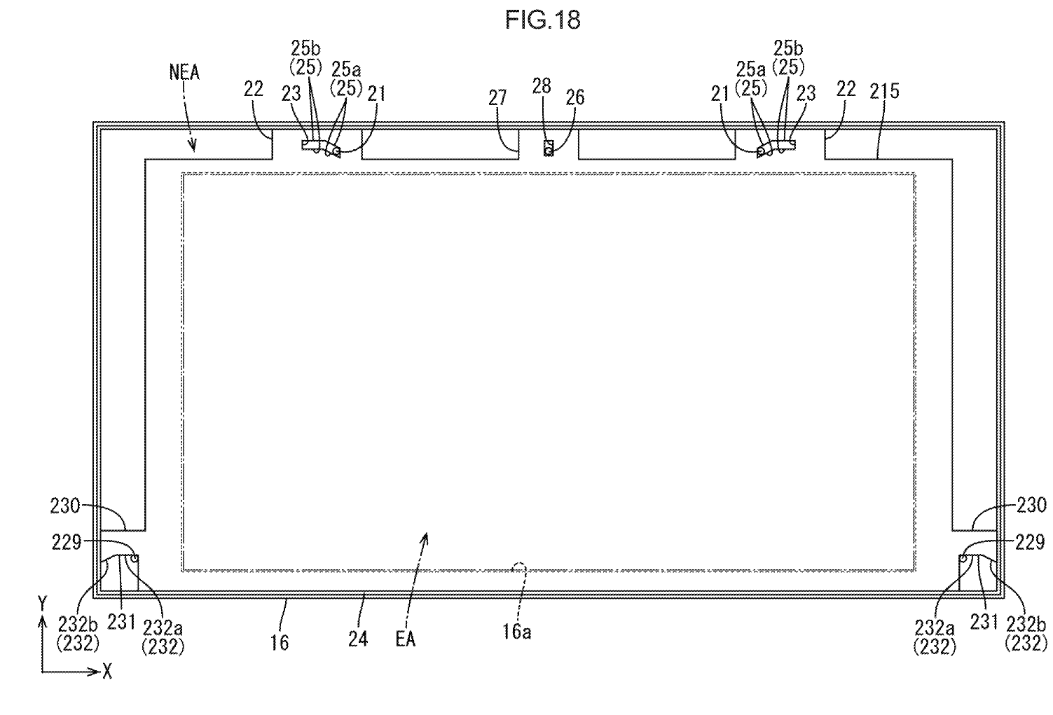

A third embodiment of the present invention will be described with reference to FIGS. 15 to 18. The third embodiment includes a second support section 230 having a configuration different from that of the second embodiment. Configurations, operations, and effects similar to those in the second embodiment will not be described.

As illustrated in FIG. 15, the second support section 230 of this embodiment has a second open section 231 where a second sheet supporter 229 is fit and the second open section 231 is open downward (an opposite side from the other edge section) with respect to the vertical direction. Namely, the second open section 231 is a recessed section at the lower part of the second support section 230 with respect to the vertical direction. According to such a configuration, compared to the second embodiment including the second hole 31 that is through the second support section 30, the second support section 230 is reduced in size and the frame width is further reduced. Specifically, an optical sheet set 215 includes a pair of second support sections 230 each projecting horizontally from each of the two side edges extending in the vertical direction. The second support sections 230 projects from a part of each of the two side edges that is slightly above from the lower edge. The second sheet supporter 229 is contacted with the lower edge section of the second open section 231 included in the second support section 230 with respect to the vertical direction. Accordingly, the optical sheet set 215 is supported at the lower edge section thereof.

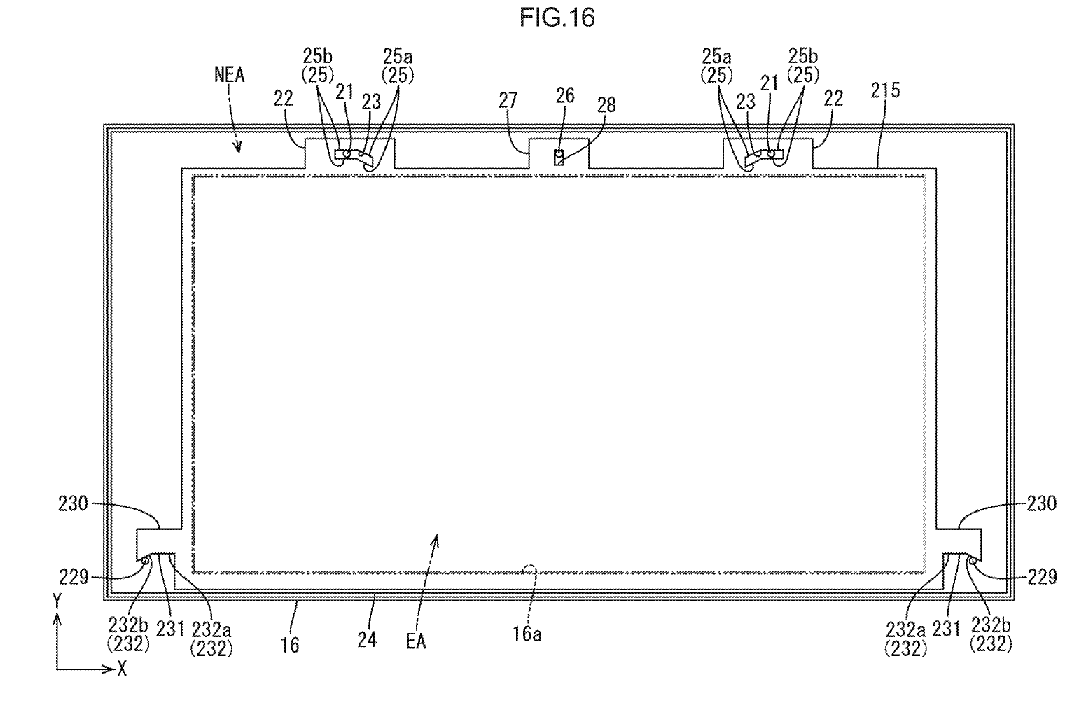

The lower edge section that is an opening edge of the second open section 231 of the second support section 230 is second contact section 232. As illustrated in FIG. 15, the second contact section 232 extends in the relative movement direction thereof with respect to the second sheet supporter 229 according to the thermal expansion of the optical sheet set 215 and is contacted with the second sheet supporter 229. The second contact section 232 is provided only on the upper side with respect to the second sheet supporter 229 in the vertical direction and is not provided on a lower side. The second contact section 232 includes a second middle side section 232a on a middle side and a second edge side section 232b on an edge side with respect to the optical sheet set 215 in the horizontal direction. The second middle side section 232a is continuous to the second edge side section 232b. Specific configurations of the second middle side section 232a and the second edge side section 232b are same as those of the second embodiment. The second support section 230 has a projecting basal part projecting from the side edge of the optical sheet set 215 and a projecting distal part. The projecting basal part has a constant height dimension and the projecting distal part has a height dimension that gradually increases toward the projecting distal end thereof and has a lower edge section that is sloped. According to such a configuration, if the optical sheet set 215 thermally expands according to the increase of the temperature from the lowest temperature environment illustrated in FIG. 15, the optical sheet set 215 expands such that the lower edge section thereof in the vertical direction moves downward in the vertical direction and the two side edge sections thereof in the horizontal direction moves laterally in the horizontal direction as illustrated in FIG. 16. During the expansion, the second sheet supporter 229 is guided by the second edge side section 232b and relatively moves along the second edge side section 232b toward the second middle side section 232a. The second edge side section 232b extends obliquely with respect to the vertical direction and the horizontal direction and changes its position toward the second middle side section 232a upwardly in the vertical direction. According to such a configuration, the second sheet supporter 229 is guided by the second edge side section 232b such that the optical sheet set 215 does not expand upwardly in the vertical direction and expand only downwardly. Next, if the temperature is increased from the first normal temperature environment to the second normal temperature environment, each second sheet supporter 229 is positioned at a border included in the second contact section 232 between the second edge side section 232b obliquely extending and the second middle side section 232a horizontally extending.

If the temperature is further increased from the second normal temperature environment and the optical sheet set 215 thermally expands, the second sheet supporter 229 that is contacted with the second middle side section 232a relatively moves toward an opposite side from the second edge side section 232b with respect to the second middle side section 232a. The second middle side section 232a extends horizontally and does not change its position with respect to the vertical direction. Therefore, the second sheet supporter 229 is guided by the second middle side section 232a and the optical sheet set 215 does not expand downward in the vertical direction and expand only upward.

As described before, according to the present embodiment, the second support section 230 has the second open section (an open section) 231 where the second sheet supporter 229 is fit. The second open section 231 is open toward an opposite side from the other edge section of the optical sheet set 215. According to such a configuration, compared to a configuration including a second open section that is a hole through the second support section 230, the second support section 230 is reduced in size and the frame width can be further reduced.

### Fourth Embodiment

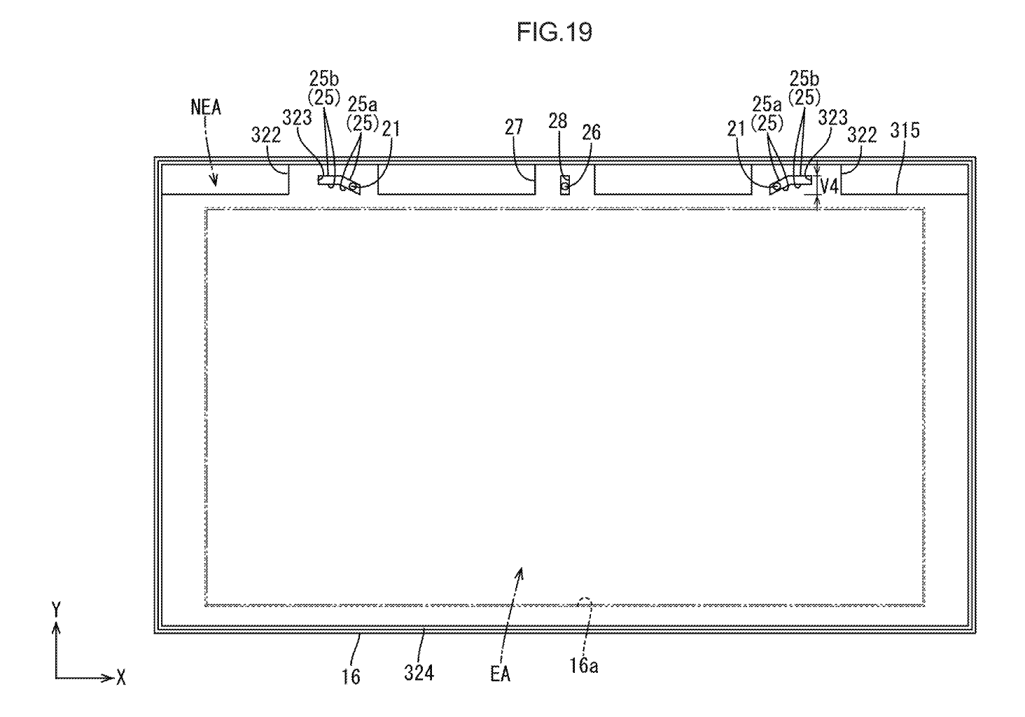

A fourth embodiment of the present invention will be described with reference to FIG. 19. In the fourth embodiment, a hole 323 has a dimension different from that of the first embodiment. Configurations, operations, and effects similar to those in the first embodiment will not be described.

As illustrated in FIG. 19, a support section 322 of this embodiment has a hole 323 having a dimension V4 in the vertical direction. The dimension V4 is greater than difference between a clearance between the lower edge section of an optical sheet set 315 and a sheet receiving section 324 in a supposed lowest temperature environment and dimension difference (V2−V1) of the vertical dimensions of the optical sheet set 315 in the lowest temperature environment and the highest temperature environment. Namely, the formula of V4>(V2−V1)−C1 is satisfied. Therefore, if the temperature is increased to the highest temperature environment as illustrated in FIG. 19, the sheet supporter 321 is above the lower edge section of the hole 323 in the vertical direction and a clearance is provided between the sheet supporter 321 and the lower edge section. According to such a configuration, similar to the first embodiment, while the temperature is increased from the lowest temperature environment to the highest temperature environment, an optical sheet set 315 can thermally expand in the vertical direction and also absorb a dimension error. Therefore, the deformation of the optical sheet set 315 such as wrinkles or warping is less likely to be caused.

### Fifth Embodiment

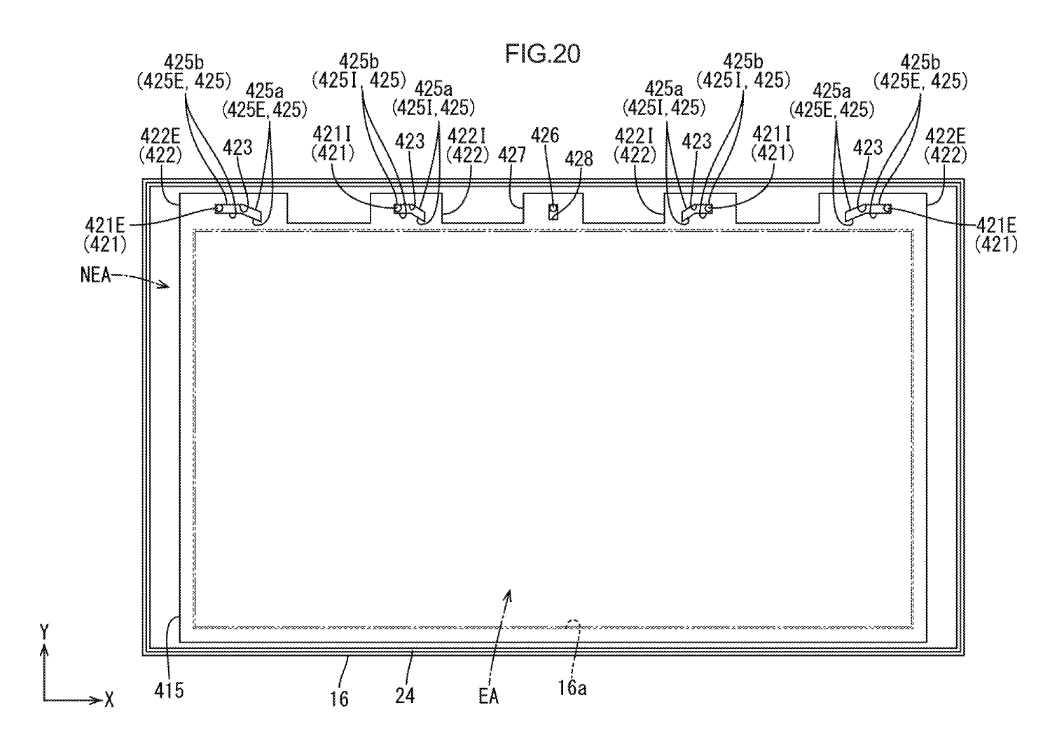

A fifth embodiment of the present invention will be described with reference to FIG. 20. In the fifth embodiment, the number of sheet supporters 421 and support sections 422 is altered from that of the first embodiment. Configurations, operations, and effects similar to those in the first embodiment will not be described.

As illustrated in FIG. 20, four sheet supporters 421 and four support sections 422 are provided in the present embodiment. The sheet supporters 421 and the support sections 422 are provided at two edge sections of an optical sheet set 415 and a frame 416 with respect to the horizontal direction and at intermediate sections between a middle position (a middle sheet supporter 426 and a middle support section 42 and the respective two edge sections. Specifically, the four sheet supporters 421 include a pair of edge side sheet supporters 421E and a pair of intermediate sheet supporters 421I. The edge side sheet supporters 421E are arranged at respective two edge sections of the frame 416 with respect to the horizontal direction. The intermediate sheet supporters 421I are arranged at intermediate sections between the middle position and the two edge sections in the horizontal direction, respectively. The intermediate sheet supporters 421I are edge side sheet supporters with respect to the middle sheet supporter 426. The four support sections 422 include a pair of edge side support sections 422E and a pair of intermediate support sections 422I. The edge side support sections 422E are arranged at two edge sections of the optical sheet set 415 in the horizontal direction. The intermediate support sections 422I are arranged at intermediate sections between the middle position and the two edge sections of the optical sheet set 415 in the horizontal direction, respectively. The intermediate support sections 422I are edge side support sections with respect to the middle support section 427. Each of the four support sections 422 includes the contact sections 425, respectively. The contact sections 425 include edge side contact sections 425E and intermediate contact sections 425I. Each of the edge side support sections 422E includes a pair of edge side contact sections 425E and each of the intermediate support sections 422I includes a pair of intermediate contact sections 425I. For the sheet supporter 421, the support section 422, and the contact section 425, the numerals are provided with “E” in referring to those arranged at the edge section, the numerals are provided with “I” in referring to those arranged at the intermediate section, and no additional character is provided to the numerals in generally referring to the components.

As illustrated in FIG. 20, the sheet supporters 421E, 421I and the support sections 422E, 422I are arranged on the same level in the vertical direction. The edge side support section 422E and the intermediate support section 422I include an edge side contact section 425E and an intermediate contact section 425I (a hole 423), respectively. The edge side contact section 425E and the intermediate contact section 425I are common in a configuration including continuously a middle side section 425a obliquely extending and an edge side section 425b horizontally extending. However, the edge side contact section 425E and the intermediate contact section 425I differ from each other in a whole forming area in the horizontal direction and an inclination angle of the middle side section 425a obliquely extending. Specifically, in the thermal expansion of the optical sheet set 415, a horizontal displacement amount of the edge side support section 422E with respect to the edge side sheet supporter 421E is greater than a horizontal displacement amount of the intermediate support section 422I with respect to the intermediate sheet supporter 421I. Therefore, the edge side contact sections 425E (the hole 423) included in the edge side support section 422E has a whole horizontal forming area that is greater than that of the intermediate contact sections 425I (the hole 423) included in the intermediate support section 422I. An inclination angle of the middle side section 425a of the edge side contact section 425E with respect to the horizontal direction is smaller than an inclination angle of the middle side section 425a of the intermediate contact section 425I with respect to the horizontal direction. The configurations of the middle sheet supporter 426, the middle support section 427, and the hole 428 are same as those of the first embodiment.

### Sixth Embodiment

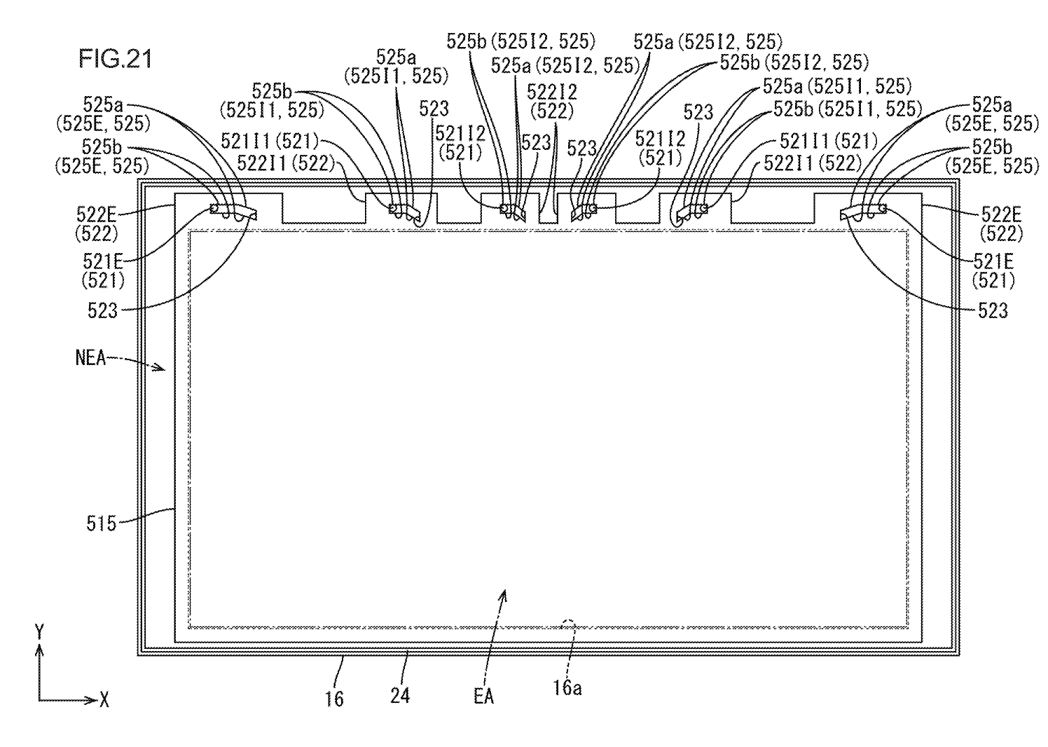

A sixth embodiment of the present invention will be described with reference to FIG. 21. In the sixth embodiment, the numbers of sheet supporters 521 and support sections 522 are altered from those of the fifth embodiment. Configurations, operations, and effects similar to those in the fifth embodiment will not be described.

As illustrated in FIG. 21, six sheet supporters 521 and six support sections 522 (contact sections 525) are provided in the present embodiment. The sheet supporters 521 and the support sections 522 are provided at two edge sections of an optical sheet set 515 and a frame 516 with respect to the horizontal direction, at first intermediate sections close to the two edge sections, and at second intermediate sections closer to the middle section. Specifically, the six sheet supporters 521 include a pair of edge side sheet supporters 521E, a pair of first intermediate sheet supporters 521I1, and a pair of second intermediate sheet supporters 521I2. The six support sections 522 include a pair of edge side support sections 522E, a pair of first intermediate support sections 522I1, and a pair of second intermediate support sections 522I2. The edge side sheet supporters 521E and the edge side support sections 522E are arranged at two edge sections in the horizontal direction. The first intermediate sheet supporters 521I1 and the first intermediate support sections 522I1 are arranged at first intermediate positions close to the two edge sections in the horizontal direction. The second intermediate sheet supporters 521I2 and the second intermediate support sections 522I2 are arranged at second intermediate positions close to the middle position in the horizontal direction. Namely, the present embodiment does not include the middle sheet supporter 426 and the middle support section 427 included in the fifth embodiment (refer FIG. 20).

Each of the edge side support sections 522E, the first intermediate support sections 522I1, and the second intermediate support sections 522I2 includes the edge side contact sections 525E, the first intermediate contact sections 525I1, and the second intermediate contact sections 525I2 (the hole 523), respectively. The edge side contact section 525E, the first intermediate contact section 525I1, and the second intermediate contact section 525I2 are common in a configuration including continuously a middle side section 525a obliquely extending and an edge side section 525b horizontally extending. However, the edge side contact section 525E, the first intermediate contact section 525I1, and the second intermediate contact section 525I2 differ from each other in a whole forming area in the horizontal direction and an inclination angle of the middle side section 525a obliquely extending. Specifically, in the thermal expansion of the optical sheet set 515, if comparing a horizontal displacement amount of the edge side support section 522E with respect to the edge side sheet supporter 521E, a horizontal displacement amount of the first intermediate support section 522I1 with respect to the first intermediate sheet supporter 521I1, and a horizontal displacement amount of the second intermediate support section 522I2 with respect to the second intermediate sheet supporter 521I2, the displacement amount of the edge side support section 522E is greatest and the displacement amount of the second intermediate support section 522I2 is smallest. Therefore, the edge side contact sections 525E (the hole 523) included in the edge side support section 452E has a whole horizontal forming area that is largest and the second intermediate contact sections 525I2 (the hole 523) included in the second intermediate support section 522I2 has a whole horizontal forming area that is smallest. An inclination angle of the middle side section 525a of the edge side contact section 525E with respect to the horizontal direction is smallest and an inclination angle of the middle side section 525a of the second intermediate contact section 525I2 with respect to the horizontal direction is greatest.

### Other Embodiments

The present invention is not limited to the embodiments, which have been described using the foregoing descriptions and the drawings. For example, embodiments described below are also included in the technical scope of the present invention.

(1) In each of the above embodiments, in the external temperature environment, the normal temperature is 25° C., the low temperature is 0° C., and the high temperature is 50° C. However, the specific temperatures of the normal temperature, the low temperature and the high temperature in the external temperature environment may be altered as appropriate.

(2) In each of the above embodiments, the lower edge section of the optical sheet set in the vertical direction is contacted with the sheet receiving section in the second normal temperature environment (the backlight unit is lighted on at the highest brightness when the external temperature environment is normal temperature). However, the lower edge section of the optical sheet set in the vertical direction may be contacted with the sheet receiving section in the temperature environment lower than the second normal temperature environment (including the first normal temperature environment and the temperature environment lower than the first normal temperature environment) or the temperature environment higher than the second normal temperature environment.

(3) In the first to fifth embodiments, the number of the sheet supporters and the support sections (the contact sections) is two or four and the middle sheet supporter and the middle support section are arranged in the middle position with respect to the horizontal direction. However, in the configuration including two or four sheet supporters and support sections (the contact sections), the middle sheet supporter and the middle support section may not be included.

(4) In the sixth embodiment, the number of the sheet supporters and the support sections (the contact sections) is six and the middle sheet supporter and the middle support section are not included. However, in the configuration including six sheet supporters and support sections (the contact sections), the middle sheet supporter and the middle support section may be included.

(5) In each of the above embodiments, the number of the sheet supporters and the support sections (the contact sections) is two, four or six. However, the number of the sheet supporters and the support sections (the contact section may be one, three, five, seven or more. In such a configuration, the middle sheet supporter and the middle support section may be included or may not be included.

(6) Other than each of the above embodiments, the horizontal arrangement of the sheet supporters and the support sections (the contact sections) may be altered as appropriate. Specifically, in the configuration of each of the first to fourth embodiments, the sheet supporters and the support sections (the contact sections) may be arranged at the edges in the horizontal direction. In the configuration of each of the fifth and sixth embodiments, the edge side sheet supporters and the edge side support sections (the edge side contact sections) may be arranged closer to the middle from the respective edges in the horizontal direction. In the configuration of the fifth embodiment, the intermediate sheet supporters and the intermediate support sections (the intermediate contact sections) may be arranged closer to the edge side sheet supporters and the edge side support sections (the edge side contact sections) in the horizontal direction or may be arranged farther away from the edge side sheet supporters and the edge side support sections (the edge side contact sections) in the horizontal direction. In the configuration of the sixth embodiment, the first intermediate sheet supporters and the first intermediate support sections (the first intermediate contact sections) may be arranged closer to the edge side sheet supporters and the edge side support sections (the edge side contact sections) in the horizontal direction or may be arranged farther away from the edge side sheet supporters and the edge side support sections (the edge side contact sections) in the horizontal direction. In the configuration of the sixth embodiment, the second intermediate sheet supporters and the second intermediate support sections (the second intermediate contact sections) may be arranged closer to the first intermediate sheet supporters and the first intermediate support sections (the first intermediate contact sections) in the horizontal direction or may be arranged farther away from the first intermediate sheet supporters and the first intermediate support sections (the first intermediate contact sections) in the horizontal direction.

(7) In each of the above embodiments, the sheet supporters are arranged in different positions in the horizontal direction and arranged in a same level in the vertical direction. However, the sheet supporters may be arranged in different positions in the horizontal direction and arranged in different positions in the vertical direction. In such a configuration, the forming areas and arrangement of the support sections and the holes in the vertical direction may be altered corresponding to the positions of the sheet supporters.

(8) In the second and third embodiments, two second sheet supporters and two second support sections (the second contact sections) are arranged. However, the number of the second sheet supporters and the second support sections (the second contact sections) may be one, three or more.

(9) In the second and third embodiments, the second support section projects horizontally from the side edge of the optical sheet set and the side edge extends in the vertical direction. The second support section may project vertically from a lower edge of the optical sheet set and the lower edge extends in the horizontal direction. Such a configuration may include a structure that prevents contact of the second support section and the sheet receiving section (for example, a recess through which the second support section is inserted is formed in the sheet receiving section) in case of the thermal expansion of the optical sheet set.

(10) In the second embodiment, the second support section having the second hole therethrough is arranged in the lower edge part of the vertically extending side edge section of the optical sheet set. However, the second support section having the second hole therethrough may be arranged in a part of the vertically extending side edge section of the optical sheet set and the part is upwardly farther away from the lower edge section.

(11) In the third embodiment, the second support section having the second open section is arranged upwardly away from the lower edge of the vertically extending side edge of the optical sheet set. However, the second support section having the second open section may be arranged at the lower edge part of the vertically extending side edge of the optical sheet set.

(12) In each of the above embodiments, the contact section is formed such that a tangent of the inclination angle of the obliquely extending middle side section with respect to the horizontal direction is equal to a ratio of a distance between the middle position of the optical sheet set in the horizontal direction and the support section to a vertical dimension of the optical sheet set. However, a contact section that is formed such that a tangent of the inclination angle of the obliquely extending middle side section with respect to the horizontal direction is not equal to a ratio of a distance between the middle position of the optical sheet set in the horizontal direction and the support section to a vertical dimension of the optical sheet set may be included in a scope of the present invention.

(13) In each of the above embodiments, the edge side sections of the contact section horizontally extend. However, the edge side sections of the contact section may obliquely extend and have an inclination angle with respect to the horizontal direction. In such a configuration, the inclination angle of the edge side sections of the contact section with respect to the horizontal direction may be smaller than the inclination angle of the middle side sections with respect to the horizontal direction.

(14) In the second and third embodiments, the second contact section is formed such that a tangent of the inclination angle of the obliquely extending edge side section with respect to the horizontal direction is equal to a ratio of a distance between the middle position of the optical sheet set in the horizontal direction and the second support section to a vertical dimension of the optical sheet set. However, a second contact section that is formed such that a tangent of the inclination angle of the obliquely extending edge side section with respect to the horizontal direction is not equal to a ratio of a distance between the middle position of the optical sheet set in the horizontal direction and the second support section to a vertical dimension of the optical sheet set may be included in a scope of the present invention.

(15) In the second and third embodiments, the second middle side section of the second contact section horizontally extends. However, the second middle side section of the second contact section may obliquely extend and have an inclination angle with respect to the horizontal direction. In such a configuration, the inclination angle of the second middle side section of the second contact section with respect to the horizontal direction may be smaller than the inclination angle of the second edge side section with respect to the horizontal direction.

(16) In each of the above embodiments, the sheet receiving section has a frame shape extending along the frame section of the frame. However, the frame section may include the sheet receiving section only at the lower long-side section thereof with respect to the vertical direction and the sheet receiving section may be configured to receive the lower edge section of the optical sheet set with respect to the vertical direction. The sheet receiving section may be arranged on the lower long-side section of the frame section and also arranged on one or both of the two short-side sections that vertically extend. The sheet receiving section may be arranged on the lower long-side section of the frame section and also arranged on the upper long-side section. The sheet receiving section may not be provided and the optical sheet set may be configured such that the lower edge thereof is not restricted by the sheet receiving section.

(17) In each of the above embodiments, the sheet receiving section extends over an entire length of the lower long-side section of the frame section of the frame with respect to the vertical direction. However, the sheet receiving section may be arranged on a part of the lower long-side section of the frame section with respect to the vertical direction. In such a configuration, multiple sheet receiving sections may be provided.

(18) In each of the above embodiments, the frame includes the sheet supporter and the sheet receiving section. However, the sheet supporter and the sheet receiving section may be included in a component other than the frame (such as the light guide plate, the bezel, and the chassis). Each of the sheet supporter and the sheet receiving section may be included in different components.

(19) In each of the above embodiments, the optical sheet set includes three kinds of optical sheets of a microlens sheet, a prism sheet, and a reflection type polarizing sheet. However, other kinds of optical sheets (a diffuser sheet that adds a diffusing effect to the light or a wavelength conversion sheet including phosphors that convers a wavelength of the light) may be included in the technical scope of the present invention.

(20) In each of the above embodiments, three optical sheets are used and the number of optical sheets may be two or less (including one) or four or more.

(21) In each of the above embodiments, the optical sheet set has rectangular outline. However, an outline of the optical sheet set may be a square, a circle, or an ellipse. In altering the outline of the optical sheet set, a planar shape of the frame may be also altered.

(22) In each of the above embodiments, the backlight unit (the liquid crystal display device) is used in a horizontal position such that the short-side direction and the long-side direction of the optical sheet set match the vertical direction and the horizontal direction, respectively. However, the backlight unit (the liquid crystal display device) may be used in a vertical position such that the long-side direction and the short-side direction of the optical sheet set match the vertical direction and the horizontal direction, respectively.

(23) In each of the above embodiments, the LED board (the LEDs) is arranged such that the lower long-side edge surface of the light guide plate with respect to the vertical direction is the light entering edge surface. However, the LED board (the LEDs) may arranged such that the upper long-side edge surface of the light guide plate with respect to the vertical direction may be the light entering edge surface. The LED board (the LEDs) may be arranged such that one of the short-side edge surfaces of the light guide plate with respect to the horizontal direction is the light entering edge surface. In such a configuration, the arrangement of the sheet supporter and the support section may be altered according to the arrangement of the LED board (the LEDs).

(24) In each of the above embodiments, the lighting unit is the one light entering type entering unit and the LED board (the LEDs) is arranged such that one of four edge surfaces of the light guide plate is the light entering edge surface. However, the lighting unit may be two-sides light entering type lighting unit and a pair of LED boards (the LEDs) are arranged such that a pair of long-side edge surfaces of the four edge surfaces of the light guide late are the light entering edge surfaces and the light guide plate is sandwiched between the LED boards with respect to the short-side direction. In such a configuration, the arrangement of the sheet supporter and the support section may be altered according to the arrangement of the LED boards (the LEDs).

(25) Other than the configuration of (24), the LED boards (the LEDs) may be arranged such that any three edge surfaces of the light guide plate may be the light entering edge surfaces or the LED boards (the LEDs) may be arranged such that all of the four edge surfaces of the guide plate are the light entering edge surfaces. In such a configuration, the arrangement of the sheet supporter and the support section may be altered according to the arrangement of the LED boards (the LEDs).

(26) In each of the above embodiments, the LED board is arranged for one side of the light guide plate. However, multiple LED boards may be arranged for one side of the light guide plate.

(27) In each of the above embodiments, the LEDs are the top surface light emission type LEDs. However, side surface light emission type LEDs may be used as the light source. The number of the LEDs mounted on the LED board may be altered as appropriate. Light source other than the LEDs (such as organic ELs) may be used.

(28) In each of the above embodiments, the edge-light type backlight unit is used. However, a direct-type backlight unit may be included in the technical scope of the present invention. In such a configuration, the direct-type backlight unit does not include the light guide plate of the edge-light type backlight unit and the LED board is arranged such that the LED mounting surface is parallel to a plate surface of the bottom of the chassis and opposite and spaced from a plate surface of the optical sheet set arranged in the light exit section of the chassis. The LED board is preferably disposed such that the LEDs arc arranged in a matrix within a plane surface of the bottom of the chassis. A reflection sheet is preferably disposed to cover the mounting surface of the LED board and preferably has LED insertion holes through which the LEDs pass. A diffuser lens may be disposed to cover the light emission surface of the LED to diffuse the light.

(29) In each of the above embodiments, the TFTs are used as switching components of the liquid crystal display device. However, a liquid crystal display device including switching components other than TFTs (e.g., thin film diodes (TFDs)) may be included in the scope of the present invention. Furthermore, other than color liquid crystal display devices, black-and-white liquid crystal display devices are also included in the scope of the present invention.

(30) In each of the above embodiments, the transmission-type liquid crystal display device is described. However, a semi-transmission type liquid crystal display device is also included in the scope of the present invention.

(31) In each of the above embodiments, the liquid crystal display device includes the liquid crystal panel as the display panel. However, a display device including other types of display panels (such as a micro elector mechanical systems (MEMS) display panel) may be included in the scope of the present invention.

(32) In each of the above embodiments, the television device including the tuner is described. However, a display device without including a tuner may be included in the scope of the present invention. Specifically, a liquid crystal display device used as an electronic signboard (a digital signage) or an electronic blackboard is also included in the scope of the present invention.

### EXPLANATION OF SYMBOLS

10: liquid crystal display device (display device), 11: liquid crystal panel (display panel), 12, 112: backlight unit (lighting unit), 15, 115, 215, 315, 415, 515: optical sheet set, 16, 116: frame (frame member), 21, 121, 321, 421, 521: sheet supporter, 22, 322, 422, 522: support section, 23, 323, 423, 523: hole, 24, 324: sheet receiving section, 25, 425, 525: contact section, 25a, 425a, 525a: middle side section, 25b, 425b, 525b: edge side section, 26, 226, 426: middle sheet supporter, 27, 427: middle support section, 28, 428: middle hole (hole), 29, 229: second sheet supporter (contact section), 30, 230: second support section, 31, 231: second open section, 32, 232: second contact section, 32a, 232a: second middle side section, 32b, 232b: second edge side section.

1. A lighting device comprising:
an optical sheet having a surface along a first direction and a second direction that are perpendicular to each other and adding an optical effect to light;
a light source arranged on one edge side of the optical sheet with respect to the first direction;
a sheet supporter configured to support another edge side section of the optical sheet with respect to the first direction;
a support section included in the other edge side section of the optical sheet and closer to an edge side from a middle position of the optical sheet with respect to the second direction, the support section being supported by the sheet supporter; and
a contact section that is included in a section of the support section and to be contacted with the sheet supporter,
the contact section including a middle side section and an edge side section on a middle side and an edge side of the optical sheet with respect to the second direction, respectively, and the middle side section being continuous to the edge side section, and
at least the middle side section extending from the edge side section obliquely with respect to the first direction and the second direction and toward the one edge side with respect to the first direction and the middle side section having an inclination angle with respect to the second direction that is greater than that of the edge side section.

2. The lighting device according to claim 1, wherein the contact section is formed such that a tangent of the inclination angle of the middle side section with respect to the second direction is equal to a ratio of a distance between the middle position of the optical sheet in the second direction and the support section to a dimension of the optical sheet in the first direction.

3. The lighting device according to claim 1, wherein the edge side section of the contact section extends in the second direction.

4. The lighting device according to claim 1, further comprising:
a middle support section included on the other edge side and in the middle position of the optical sheet with respect to the second direction and having a hole; and
a middle sheet supporter configured to support the middle support section and to be inserted through the hole of the middle support section, wherein
the hole has a dimension in the first direction that is greater than that of the middle sheet supporter.

5. The lighting device according to claim 1, further comprising a sheet receiving section arranged on an opposite side from the sheet supporter with respect to the first direction while having the optical sheet therebetween, the sheet receiving section configured to receive a one edge side section of the optical sheet with respect to the first direction, wherein
the sheet receiving section is away from the one edge side section of the optical sheet in a relatively low temperature environment and the sheet receiving section is in contact with the one edge side section of the optical sheet in a relatively high temperature environment.

6. The lighting device according to claim 5, further comprising a frame member extending along an outer edge of the optical sheet, the frame member including the sheet supporter and the sheet receiving section.

7. The lighting device according to claim 1, wherein the contact section includes at least two contact sections having the sheet supporter therebetween.

8. The lighting device according to claim 1, wherein the support section is a projection projecting from a part of an outer edge of the optical sheet.

9. The lighting device according to claim 8, further comprising:
a middle support section included on the other edge side and in the middle position of the optical sheet with respect to the second direction, the middle support section projecting from the outer edge of the optical sheet toward a same side as the support section in the first direction; and
a middle sheet supporter configured to support the middle support section.

10. The lighting device according to claim 1, further comprising:
a second sheet supporter configured to support a one edge side section of the optical sheet;
a second support section included in the one edge side section of the optical sheet and supported by the second sheet supporter; and
a second contact section included in a section of the second support section that is to be contacted with the second sheet supporter,
the second contact section including a second middle side section and a second edge side section on a middle side and an edge side of the optical sheet with respect to the second direction, respectively, and the second middle side section being continuous to the second edge side section, and
at least the second edge side section extending from the second middle side section obliquely with respect to the first direction and toward an opposite side from the other edge side with respect to the first direction and the second edge side section having an inclination angle with respect to the second direction greater than that of the second middle side section.

11. The lighting device according to claim 10, wherein the second contact section is formed such that a tangent of the inclination angle of the second edge side section with respect to the second direction is equal to a ratio of a distance between the middle position of the optical sheet in the second direction and the second support section to a dimension of the optical sheet in the first direction.

12. The lighting device according to claim 10, wherein the second middle side section of the second contact section extends in the second direction.

13. The lighting device according to claim 10, wherein the second support section has an open section where the second sheet supporter is fit and that is open toward an opposite side from the other edge side of the optical sheet with respect to the first direction.

14. A display device comprising:
the lighting device according to claim 1; and
a display panel displaying an image with using light supplied by the lighting device.
